(19) United States
(12) Patent Application Publication
(10) Pub. No.: US 2024/0375884 A1
(43) Pub. Date: Nov. 14, 2024

(54) AUTOMATED CONVEYOR WITH PRODUCT CLASSIFICATION AND REJECTION

(71) Applicant: BURTOFT, LLC, Caldwell, ID (US)

(72) Inventor: Matthew Robert McCafferty, Caldwell, ID (US)

(73) Assignee: BURTOFT, LLC, (omitted)

(21) Appl. No.: 18/662,531

(22) Filed: May 13, 2024

Related U.S. Application Data
(60) Provisional application No. 63/466,221, filed on May 12, 2023.

(51) Int. Cl. B65G 47/24; B65G 47/88

(52) U.S. Cl. CPC B65G 47/24; B65G 47/8861; B65G 2203/042

(57) ABSTRACT

An apparatus is provided to correct an orientation of a product conveying within a plurality of products on a conveyor along a conveying direction. The apparatus may be adapted to lift or rotate improperly oriented products in a response to a signal from a sensor. The apparatus may include one or two devices with an arm attached to an actuator and a product clamp. The apparatus may be also adapted to classify and remove uncompliant products from a conveyor line with one or more sensors and additional actuated devices positioned along a conveyor. The apparatus may be also adapted with a movable rail to adjust a working width of the conveyor.

### CROSS-REFERENCE TO RELATED APPLICATIONS

This nonprovisional application claims the benefit of priority, under 35 U.S.C. .sctn. 119(e), to a pending U.S. Provisional Patent Application Ser. No. 63/466,221 filed on May 12, 2023 and titled “AUTOMATED CONVEYOR WITH PRODUCT CLASSIFICATION AND REJECTION”, which is hereby incorporated by reference in its entirety.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### TECHNICAL FIELD

The subject matter relates to conveying of products. The subject matter may relate to classifying conveying of products. The subject matter may relate to resolving an occurrence of a non-compliant product within a plurality of conveying products. The subject matter may relate to an apparatus adapted to identify orientation of each product from a plurality of conveying products and to change an incorrect orientation of the product individually. The subject matter may relate to an apparatus adapted to sense an identity of a product and remove insufficiently identified product from a conveyor.

### BRIEF DESCRIPTION OF THE DRAWINGS

The accompanying drawings are incorporated in and constitute part of the specification and illustrate various embodiments. In the drawings:

FIG. 1 illustrates one perspective view of an apparatus designed to adjust a working width of a conveyor;

FIG. 2 illustrates an end view of the apparatus of FIG. 1;

FIG. 3 illustrates a top view of the apparatus of FIG. 1;

FIG. 3A illustrates a partial cross-sectional view of a pivotal connection along lines 3A-3A in FIG. 3;

FIG. 4 illustrates another perspective view of the apparatus of FIG. 1;

FIG. 5 illustrates an end view of the apparatus of FIG. 4;

FIG. 6 illustrates a top view of the apparatus of FIG. 4;

FIG. 7 illustrates a perspective view of an apparatus designed to change an orientation of a product;

FIG. 8 illustrates a perspective view of an apparatus;

FIG. 9 illustrates a partial enlarged perspective view of the apparatus of FIG. 8;

FIG. 10 illustrates a perspective view of the apparatus of FIG. 8 with an optional product clamp;

FIG. 11 illustrates an enlarged perspective view of the clamp of FIG. 10;

FIG. 12 illustrates a perspective view of the apparatus with an optional product clamp;

FIG. 13 illustrates a diagram of an apparatus;

FIG. 14 illustrates a perspective view of a conveyor;

FIG. 15 illustrates a top view of the conveyor of FIG. 14;

FIG. 16 illustrates an elevation view of the conveyor of FIG. 14;

FIG. 17 illustrates one partial elevation view of the conveyor of FIG. 14;

FIG. 18 illustrates another partial elevation view of the conveyor of FIG. 14;

FIG. 19 illustrates a partial perspective view of the conveyor of FIG. 14;

FIG. 20 illustrates a partial perspective view of the conveyor of FIG. 14;

FIG. 21 illustrates a partial perspective view of the conveyor of FIG. 14;

FIG. 22 illustrates a plan view of a conveyor;

FIG. 23 illustrates a perspective view of a product orienting apparatus;

FIG. 24 illustrates a perspective view of the product orienting apparatus of FIG. 23;

FIG. 25 illustrates a perspective view of a sensor assembly;

FIG. 26 illustrates a perspective view of a product turning device with a notched arm;

FIG. 27 illustrates a perspective view of a product turning device with a star-shaped wheel;

FIG. 28 illustrates a planar view of a bump turner;

FIG. 29 illustrates a perspective view of a product reject accumulation apparatus;

FIG. 30 illustrates a perspective view of a transfer conveyor;

FIG. 31 illustrates a perspective view of an apparatus with an inclined chute to move rejected product from the line

FIGS. 32A-32B illustrate an arm provided as a U-shaped component;

FIG. 33 illustrates an arm designed with a tapered end; and

FIG. 34 illustrates an apparatus adapted to orient a product.

### DETAILED DESCRIPTION

Prior to proceeding to the more detailed description of the present subject matter, it should be noted that, for the sake of clarity and understanding, identical components which have identical functions have been identified with identical reference numerals throughout the several views illustrated in the drawing figures.

Features which are described in the context of separate embodiments may also be provided in combination in a single embodiment. Conversely, various features which are, for brevity, described in the context of a single embodiment, may also be provided separately or in any suitable subcombination. The Applicant hereby gives notice that new Claims may be formulated to such features and/or combinations of such features during the prosecution of the present Application or of any further Application derived therefrom.

It is to be understood that the singular forms “a,” “an,” and “the” include plural referents unless the context clearly dictates otherwise or expressly specified otherwise. Thus, for example, reference to “a component surface” includes reference to one or more of such surfaces.

For purposes here, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or,” “only one of,” or similar language; or (ii) two or more of the listed alternatives are mutually exclusive within the particular context, in which case “or” would encompass only those combinations involving non-mutually-exclusive alternatives. For purposes here, the words “comprising,” “including,” “having,” and variants thereof, wherever they appear, shall be construed as open-ended terminology, with the same meaning as if the phrase “at least” were appended after each instance thereof.

The verb “may” is used to designate optionality/noncompulsoriness. In other words, something that “may” can, but need not.

Before elucidating the subject matter shown in the Figures, the present disclosure will be first described in general terms.

An apparatus may be adapted to correct an orientation of a product conveying within a plurality of products on a conveyor along a conveying direction or a flow direction.

The product may be a container. The container may be a one-gallon plastic jug containing a beverage. The container may be a half-gallon plastic jug containing a beverage. The container may be a corrugated box. The container may be a crate. The container may be a pallet. The container may be a carton container containing a beverage. The beverage may be milk. The beverage may be juice.

The container may be filled with a liquid, or semi-solid, or generally solid. The container may be a carton container containing cereals. The container may contain granulated items, such as anyone of seeds, candy, granulated (or fine) powder. The product may be a block of cheese. The product may be a milk case. The product may be a pallet.

The apparatus may be configured with an arm, a first pivot connection between one end of the arm and a stationary component, an actuator, and a second pivot connection between another end of the arm and the actuator. The actuator may be designed to generate a linear motion. This actuator may be provided as a cylinder. This actuator may be provided as a solenoid. The actuator may be designed to generate a rotational motion. This actuator may be provided as a rotary solenoid.

The stationary component may be provided as a portion of a conveyor. The arm and the actuator may be mounted to pivot the product in a vertical direction in a response to a receipt of a signal. The signal may be outputted from a sensor. The signal may be outputted from a control unit receiving a signal from the sensor. The arm and the actuator may be mounted to pivot the product in a horizontal direction.

The arm may be shaped and sized to contact a portion of the product. The arm may be adapted to accommodate a shape of the product or accommodate an orientation requirement of the product. The arm may be provided as a flat component. The arm may be provided as a channel-shaped component. The arm may be provided with an L-shaped configuration. The arm may have a contoured shape The arm may have a combination of flat and contoured surfaces.

The arm may be disposed in a horizontal plane during use of the apparatus, particularly being in a position prior to a contact with the product. When the arm is provided as an L-shaped component, essentially defining two flanges at 90 degrees to each other, one (or first) flange to be disposed in a horizontal plane to receive the product thereon and the other (or the second) flange to be disposed in a vertical plane to function as a guard, preventing the product moving laterally and potentially falling off of the working surface of the conveyor. The second flange also functions as a guard as the product is being lifted by way of a pivoting from its side into an erect position resting on its bottom surface. Thus, the arm may function to both lift the product in a vertical plane and prevent an unintended movement of the product in a horizontal plane.

The arm may be adapted with a tapered end. This arm may be mounted to travel in a vertical direction with the tapered end lifting the product.

The angle between the flanges does not have to be a right angle. The angle may be an obtuse angle. The angle may be a compound (combination of angles) to help lead products into its “nested” desired position while the arm is receiving the product to be lifted upward. A bottom edge of taper may travel upward beyond the mid point, to mitigate an incomplete orientation.

The arm may be configured to at least reduce if not eliminate a friction while moving in a contact with the product. The arm may be adapted with low friction material or coating, for example such as ultra-high-molecular-weight (UHMW) polyethylene. The first arm may be adapted with one or more rollers.

The arm may be mounted above, below, or alongside the product being oriented. Contact with the product may be in a single location or a plurality of locations. Contact with the product may be provided in a single point of contact. Contact with the product may be provided as a plurality of contact points. Contact with the product may be provided as a plane (including contoured plane) [which may be needed for fragile, or easily damaged/deformed objects].

The arm may be adapted with a stop at one end of the arm.

The arm may be provided as a U-shaped component to at least partially cage the product, with the middle portion of the U-shape acting as a stop.

The arm may be further designed with a pivot to pivot the stop between a position closing the end of the arm and a position opening the end of the arm. The pivot may be a hinge with a torsion spring to open the end of the arm due to a force of the conveying product behind the product being oriented.

An actuator, as described above, may be mounted on the arm and connected to a stop to move the stop between the two positions.

It will be understood that the control unit will include components (valves, relays, switches, etc) to complement the drive and/or actuator type.

The control unit may include a programmable logic control (PLC) module. The control unit may include a microprocessor-based control module. Either module may be provided separately from valves, relays, switches, etc. The control unit may be provided as a pneumatic logic.

The apparatus may be configured with a first arm, a first pivot connection between one end of the first arm and a stationary component, a first actuator designed to generate a motion in a first direction, a second pivot connection between another end of the first arm and the first actuator, wherein the first arm may be adapted to move between a first position and a second position, a second actuator designed to generate a motion in a second direction, and a second arm attached to the second actuator, wherein the second arm may be adapted to move linearly between a third position and a fourth position along the second direction.

The first arm may be the arm as described above. The second arm may be also the arm as described above. The second arm may be also provided as an L-shaped component with two flanges. The second arm may function as a stop to prevent the over pivoting of the product pivoted into the vertical direction. The second arm may be adapted to stop the product laying on its surface from advancing further on the conveyor. In other words, the second arm may function as a stop for product to be lifted. The second actuator may be controlled in a response to the signal from the sensor to advance the second arm over the working surface to stop any movement of the fallen product even before the first actuator is actuated to move the first arm and orient, by a pivoting motion, the product into the erect position.

The second arm may be disposed downstream of the first arm along a flow direction.

The second arm may be provided as a stop and the actuator as described above. In other words, the second arm and the second actuator may be mounted on the first arm.

The second arm and the first arm may be disposed opposite of each other.

Each arm may be provided as two or more arms or portions to accommodate a shape and/or a size of the product.

In view of the above, this device may be used for changing an orientation of a product, using a pivoting (first) arm below the plane of the object being turned, and a “capturing” member, the second arm, that may move in and out of a specific position.

The first arm may pivot from a single point.

The first arm may move in a diagonal direction, causing the product to be oriented to rotate.

Both the first arm and the second arm may be provided without actuators and may be moved manually.

The pivoting arm, that changes the orientation of the product, may be operated by a cylinder (electric or hydraulic), or a servo operated device (such as a belt drive with encoder or linear actuator) and has one or more pivot points, to erect an item in a controlled way. The product to be oriented can be captured on one or more planes.

The pivoting arm may require a device to stop the object being oriented. This stop may have one or more captured faces or planes, to control the product being oriented.

The downstream second arm may be moved to one or more locations (for example, the downstream arm may be a fixed position item that is used to orient every product travelling down the line of one product type, but may be manually or automatically moved/removed, for other products that do not need to be rotated.

The downstream arm may move vertically, horizontally, or at an angle.

In the case of a jug or carton travelling on its side, the downstream arm may travel into the path of the fallen object, ahead of the fallen product, as the fallen product travels toward the downstream member. Once the fallen product makes contact with the downstream arm (having travelled into the path of the fallen product), the rotating member, from under the fallen product, will pivot, or push the product from a horizontal plane to a vertical plane. When the product has completed orientation, the downstream arm will move out of the way of the product, to continue its travel in the correct orientation, and the pivoting or pushing arm moves back out of the way of other products conveying down the conveyor.

When the product is vertical, the second actuator is controlled to move the second arm away from the product and allow product conveyance in a flow direction.

The apparatus may be adapted with another device designed to actuate, in a response to the signal from the sensor to temporarily terminate movement of the products behind the product laying on its side surface so as to at least prevent the following products from impeding first and second devices from correcting orientation of the product. Such another device may be referred to as a product clamp described further in this document.

The second actuator may be controlled to move the second arm away from the product after the clamp opens allowing flow of products to contact just erected product and stabilizing a line of products advancing on the working surface where each product is essentially being in a contact with a product in front and a product behind.

The sensor may be adapted to sense a condition of the product. The condition may define an orientation of a product in a horizontal plane. The condition may define an orientation of a product in a vertical plane. The condition may define an orientation of a gable on a carton. The intended orientation may be that the gable is parallel with the conveying direction of the carton. If the carton is turned, and the gable is perpendicular to the conveying direction, then the carton may have packaging issues downstream. The packaging issue may include inability to pick up the carton in a wrong orientation with the gripper. The condition may define a product laying on its side surface, i.e. a fallen product.

The sensor may be provided as a camera.

The sensor may be provided as one or more limit switches positioned to contact the conveying product to generate a signal.

The sensor may be provided with a sensing element and a pivoting (rocking) target that would actuate the sensing element upon contacting the product. A control unit or a controller may be then programmed to receive a signal from the sensing element at a time intervals depending on a size of the product. Lack of a signal at an expected time interval signals a void in the conveying chain of products that may be due to a fallen product.

The sensor may also include a sensing target.

The sensor may be designed with a bracket, a second bracket, a sensor mounted on the first bracket, and the sensing target mounted on the second bracket.

The sensor may be designed with a first bracket, a second bracket, two sensors mounted at a first distance from each other on the first bracket, and two sensing targets mounted at a second distance from each other on the second bracket.

The sensor may be provided as a photo eye with the sensing target provided as a reflector. The sensor may output a signal when the photo eye does not sense a reflection from the reflector.

When the sensor is provided with two sensing elements, the signal may be generated in a response to an upper sensing element not sensing the product.

Having two or more photo eyes, one above another, may be used to verify positioning of a travelling product.

The operation of the above sensor may be illustrated on conveyance of a product, being a carton container with a gable.

When the carton with the gable is conveyed with the gable parallel with the flow direction a photo eye down low, which could be a first photo eye, will be “blocked”, identifying that the carton is travelling by, then an upper photo, positioned to sense the gable, would be blocked concurrently, confirming that the product is in the correct orientation.

If the carton is conveyed with the gable perpendicular to the flow direction, then a photo eye down low, will be “blocked”, identifying that the carton is travelling by, but the photo eye at the gable level would show “daylight”, i.e. would see a reflection from the target, then “blocked”, then “daylight”, demonstrating a wrong orientation of the carton.

The operation of the above sensor may be also illustrated on conveyance of any product that is fallen. One photo eye is positioned to sense an upper portion of the product when the product is erect. When the product has fallen during conveyance, the lower photo eye will be blocked but the upper photo eye would show “daylight”.

The sensor may be provided as a combination of a photo eye with a reflector and a sensor with a rotating target, that may be referred to as a flag. When the flag dips into a jug conveying without a cap, the signal from the sensor is lost, and then made again on the opposite side of the jug opening.

When this occurs, while the photo eye, set at the jug neck height, is blocked, then the signal from the sensor communicates a missing cap condition. Thus, this sensor may be also provided as a mechanical cap inspection device.

When the product is of a sufficient size, for example a one-gallon jug crate, to at least significantly discard a possibility of the product overtipping, the second actuator and the second arm may be omitted. Actuation speed of the first device may be also controlled to slowly lift the product.

The conveyor may be stopped temporarily in a response to the signal to facilitate lifting motion.

The apparatus may be configured with a first arm with a first end and a second end, the second end positionable above a working surface of a conveyor mediate first and second sides of the conveyor, a fixed connection between the first end of the first arm and a first rail of the conveyor, an adjustable connection between the second end of the first arm and the first rail, the adjustable connection designed to bias a product conveying on the conveyor toward a second rail of the conveyor, a second arm with a first end and a second end, the second end of the second arm positioned above the working surface mediate first and second sides to turn the product in a response to a contact between the product and the second end of the first arm, the second end of the second arm having a Z-shaped configuration, a fixed connection between the first end of the second arm and the second rail, a linear actuator, and a connection between the linear actuator and the second end of the second arm.

The apparatus may be configured with an arm with an edge notch between terminal ends of the arm. The notch being shaped and sized to contact a surface of the product.

The apparatus may further include a sensor adapted to identify a condition of the product and output the signal. The signal may identify the product in a wrong orientation. For example, the wrong orientation may define a product on its side surface.

The sensor may be designed with a first bracket, a second bracket, two sensors mounted at a first distance from each other on the first bracket, and two targets mounted at a second distance from each other on the second bracket. The sensor may be provided as a photo eye. The target may be provided as a reflector for a beam of light emitted from the photo eye.

The apparatus may be adapted with a first sensor and a second sensor positioned at a distance from each other.

The apparatus may be adapted with a device designed to at least temporarily restrict conveyance of the product along the conveying direction. The product may be conveyed on a conveyor. The device may be designed as a product clamp. The device may be designed to selectively apply a force to the product and release the application of force therefrom. This device may function to provide a separation between the product to be corrected from other products that are being conveyed behind it.

The device may be designed with a first component, a second component positionable at a distance from the first component, and an actuator connected to one component from first and second components to pivot the one component toward to other component from the first and second components in a response to a receipt of a first control signal and pivot the one component away from the other component in a response to a second control signal.

The device may be designed with a first component, a second component positionable at a distance from the first component, the distance sufficient to pass the product therethrough, and an actuator connected to one component from first and second components to move the one component toward to other component from the first and second components in a response to a receipt of a first control signal and move the one component away from the other component in a response to a second control signal.

The apparatus may include a conveyor adapted to convey the plurality of products.

The conveyor may be designed with a first end, a second end disposed opposite the first end along a length of the conveyor, a first side between first and second ends, a second side opposite the first side across a width of the conveyor, and a working surface between first and second ends and between first and second sides. A first and a second rail may be also provided. The first rail may extend along the first side of the conveyor and being mounted thereto. The second rail may extend along the second side of the conveyor. A device may be connected to one rail from first and second rails, the device adapted to move the one rail toward another rail from the first and second rails in a response to a receipt of a control signal.

The apparatus may be adapted with a sensor adapted to sense an orientation of a product, a first device configured to correct the orientation of the product, and a second device adapted to at least temporarily clamp the product.

The first device may be configured with a first arm, a first pivot connection between one end of the first arm and a stationary component, a first actuator designed to generate a linear motion in a first direction, a second pivot connection between another end of the first arm and the first actuator, wherein the first arm may be adapted to move between a first position and a second position, a second actuator designed to generate a linear motion in a second direction, and a second arm attached to the second actuator, wherein the second arm may be adapted to move linearly between a third position and a fourth position along the second direction.

The first position may be a horizontal position. Thus, the first direction may be a direction between a horizontal position and a vertical position. The second position may be a vertical position. The second direction may be in a horizontal plane.

The second device may be the clamp, as described above.

The sensor is positioned to sense orientation of the product. The sensor may be positioned, along a flow direction, between the first device and the clamp. When the sensor senses an incorrect orientation of the product, the sensor outputs a signal. Thus, the signal may define a product in a wrong orientation. For example, the product, such as a product, may be laying on its side rather than being erect. The signal may be received at a control unit. The signal may be received at a control module at the first device. The first device may be actuated in a response to the signal from the sensor. Upon receipt of the signal, the first device will be actuated to move the first arm, now positioned under the product laying on its side, from the horizontal position into a vertical position where the product is now being erect. In the vertical position, the product may contact the second arm, moved by the actuated second device toward the product, so as to prevent unintended movement of the product from the vertical position back into the horizontal position. The second device may be also actuated in a response to the signal. The clamp may be also actuated in response to the signal to temporarily restrict conveyance of the following products. Then, the first device may be actuated to lower the first arm. The first device may be returned into the original position due to a force from an internal bias member when the connection between the power source and the first actuator is terminated. The second device will be actuated or de actuated to move the second arm away from the contact with the product thus allowing movement of the product along the flow (conveying) direction. Finally, the clamp is deactuated to allow conveyance of the products.

An apparatus may be adapted with a first elongated arm with a first end and a second end and a bend between first and second arms, a second elongated arm, the second arm being straight between terminal ends of the second arm, and an assembly designed to adjust a distance of one end from first and second ends of the first elongated arm in a relationship to the second elongated arm.

An apparatus may be adapted with a conveyor, a first rail, a second rail and a device designed to move the second rail toward to and away from the first rail.

The conveyor may be designed with a first end, a second end disposed opposite the first end along a length of the conveyor, a first side between first and second ends, a second side opposite the first side across a width of the conveyor, and a working surface between first and second ends. The distance between the first and second ends defines a flow direction of the product. The flow of the product is to be understood as a flow along a length of the conveyor. The flow direction may be also referred to as a conveyance direction of a conveying direction. Thus, one end may be referred to as an inlet end and the other end may be referred to as an outlet end of the conveyor. Inlet end may be also referred to as an infeed end, i.e. the end where the product enters the conveyor or the end where the product is being fed onto the conveyor. The first side may be referred to as one side and the second side may be also referred to as another side. Either side may define a side edge of the conveyor.

The conveyor may be adapted with a frame that defines the first and second ends and the first and second sides. The conveyor may be further adapted with a drive, a driving pulley mounted for a rotation and connected to an output portion of the drive, a driven pulley disposed at a distance from the driving pulley and mounted for a rotation, and an endless component caging driving and the driven pulleys.

The drive is connectable to a source of energy. The energy may be an electric energy. The energy may be a fluid under pressure. The fluid may be air. The fluid may be a hydraulic fluid.

The driving pulley may be mounted on the output portion of the drive. The driving pulley may be mounted on its own spindle (shaft) and connected to the output portion of the drive with a coupling.

The endless component may be a chain. The endless component may be a belt. The endless component may be a cable. The endless component may be a wire. The endless component defines a working surface. In an example of a belt, a surface of the belt that can be easily viewed from outside of the conveyor provides the working surface. When the endless components is wider than the frame, the endless component may define the side of the conveyor.

The conveyor may be provided without a drive when the products are conveyed on a downwardly slopped working surface.

The first rail is mounted to extend along the first side of the conveyor. The first rail may be mounted to the first side in a fixed position. The first rail may extend an entire length of the conveyor. The first rail may extend a portion of the entire length of the conveyor. The first rail may be provided as a plurality of first rail portions. In other words, the first rail does not have to be a single continuous component. The first rail may be adjustably mounted to the side of the conveyor by way of a by way of one or more cut-outs through a thickness of the side and fasteners.

The first rail may be directly mounted to the conveyor. The first rail may be indirectly mounted to the conveyor with additional components. For example, the first rail may be provided as an elongated component and may be disposed at a distance from the working surface with one or more brackets. The distance of the elongated rail from the working surface may depend on a size and/or shape of a product being conveyed. Thus, the first rail may be used as a guide to guide the conveyance of the product along the flow direction. The first rail may be also used as a barrier or a guard to prevent an unintended movement of the product from the working surface and to further prevent the product from falling of the working surface.

The second rail extends along the second side of the conveyor. The second rail may be referred to as another rail. The second rail may be designed to move toward to and away from the first rail.

Thus, the second rail may be mounted in an adjustable manner to adjust a working width of the conveyor and, more particularly, of the working surface of the conveyor. The working width may be adjusted to convey products of different sizes (and/or shapes) without altering orientation of such products. The working width reduces when the second rail moves toward the first rail. When the effective working width reduces, there is a narrower distance between the first and second rails. The working width increases when the second rail moves away from the first rail.

The working width may be also referred to as an operating width of the conveyor. The working width may be also referred to as an effective working width of the conveyor.

The second rail may be manually moved toward to and away from the first rail, for example by being supported on brackets attached to the frame. Fasteners or clamps may be provided to at least temporarily fix a position of the second rail.

The second rail may be connected to the device adapted to move the second rail. The device may be designed to move the second rail toward the first rail in a response to a first signal and move the second rail away from the first rail in a response to a second signal. The device may be designed to move the second rail in one direction (either toward or away) in a response to a signal and move the rail in an opposite direction by way of a bias member when the signal is no longer present. The bias member may be a spring.

The device may be designed with an actuator connected to each of the conveyor and the second rail, the actuator designed to generate a linear movement of the second rail and a guide connected to each of the conveyor and the second rail, the guide designed to guide the linear movement of the second rail.

The device may be designed with an actuator connected to each of the conveyor and the second rail, the actuator designed to generate a pivoting movement of the second rail, and a guide connected to each of the conveyor and the second rail, the guide designed to guide the pivoting movement of the second rail.

The guide may be designed with a first bracket rigidly connected to the conveyor, a first arm with one end rigidly connected to the second rail and with another end pivotally connected to the first bracket, a second bracket disposed at a distance from the first bracket along the length of the conveyor, the second bracket rigidly connected to the conveyor, a second arm with one end rigidly connected to the second rail and with another end pivotally connected to the second bracket, a third bracket disposed mediate first and second arms, the third bracket rigidly connected to the conveyor, a pivotal connection between the actuator and one arm from first and second arms, and a pivotal connection between the actuator and the third bracket.

Each bracket from first, second, and third brackets may be designed as an L-shape member with one leg being attached to the conveyor (frame) and the other leg positioned to extend away from the conveyor to support a respective arm or the actuator. The bracket may be permanently attached to the conveyor, for example by a welding process. The bracket may be releasably attached to the conveyor, for example with one or more cut-outs and fasteners.

The device may be designed with a first bracket, a first arm with one end pivotally connected to the first bracket, a second bracket, a second arm with one end pivotally connected to the second bracket, a third bracket, an actuator, a pivotal connection between the actuator and one arm from first and second arms, and a pivotal connection between the actuator and the third bracket.

The pivotal connection may include aperture(s) and a shaft or a pin received within the aperture(s). In an example, an arm may be adapted with one aperture and a bracket may be adapted with another aperture. The shaft or the pin may be at least partially threaded.

The actuator may be provided as a cylinder. The actuator may be provided as a linear actuator. The actuator may be provided as a rotary solenoid. The actuator may be provided as a linear solenoid. In either form, the actuator may be designed to operate with one of an electric energy and a fluid energy. The fluid energy may be of a pneumatic or a hydraulic type.

The device may be provided as a kit of parts to be assembled in the field and attached to an existing conveyor.

The apparatus may be adapted with a dedicated control unit or a controller to control operation of the drive and actuator. It will be understood that the control unit will include components (valves, relays, switches, etc) to complement the drive and/or actuator type.

The control unit may include a programmable logic control (PLC) module. The control unit may include a microprocessor-based control module. Either module may be provided separately from valves, relays, switches, etc. The control unit may be provided as a pneumatic logic.

In operation, when the actuator is provided as the cylinder, the cylinder is affixed to a bracket, and the bracket is affixed to the conveyor. The cylinder is also connected to the second rail that is moving. When the cylinder rod pushes out in a response to a first signal at the cap end, the second rail advances in the direction of the extending cylinder rod, and there is an opposite motion of the second rail, when the cylinder is retracting. Again, the cylinder may retract due to a second signal at the rod end. The rod may retract due to an internal spring when the first signal is discontinued.

In view of the above, two different dimensions are provided between the second rail, that is moving, and the first (opposite) rail (on the opposite side of the conveyor). If the rails are too far apart (inside dimension), then the product may rotate as it conveys in the flow direction, and change the orientation on the working surface. The incorrect orientation of the product may affect further processing of the product, for example such as casing. Narrowing the distance between first and second rails, thus narrowing the effective working width of the conveyor, to accommodate a narrower product, keeps such narrower product from turning, while it is conveying (traveling).

The distance between the first and second rails may be adjusted so that the product contacts the first and second rail throughout the entire length of the conveyance. In other words, the distance may be adjusted to be substantially equal to the product width. The distance between the first and second rails may be adjusted so that a clearance is provided between the product and one or both rails. In other words, the distance may be adjusted to be greater than the product width. The clearance may be in a range between 0.125 inches and 0.5 inches. The clearance may be in a range of up to 0.5 inches. The clearance may be in a different range from above but not to impact unintended disruption to orientation or a disruption to conveyance speed of the product.

When the actuator is provided as the cylinder, proportional valve(s) may be used to accommodate more than two different sizes of the product.

It would be understood from the above that this device is designed to adjust the working width of the conveyor.

It would be also understood from the above that this device is designed to vary the working width of the conveyor. In other words, the apparatus maybe adapted with a variable width conveyor.

An apparatus may be designed with a conveyor, a first rail, a second rail and a device designed to rotate a product traveling or conveying on the conveyor.

The conveyor may be designed with a first end, a second end disposed opposite the first end along a length of the conveyor, a first side between first and second ends, a second side opposite the first side across a width of the conveyor, and a working surface between first and second ends and between first and second sides. The distance between the first and second ends defines a flow direction. Thus, one end may be referred to as an inlet end and the other end may be referred to as an outlet end of the conveyor. Inlet end may be also referred to as an infeed end, i.e. the end where the product enters the conveyor or the end where the product is being fed onto the conveyor. The first side may be referred to as one side and the second side may be also referred to as another side.

The conveyor may be adapted with a frame that defines the first and second ends and the first and second sides. The conveyor may be further adapted with a drive, a driving pulley mounted for a rotation and connected to an output portion of the drive, a driven pulley disposed at a distance from the driving pulley and mounted for a rotation, and an endless component caging driving and the driven pulleys.

The drive is connectable to a source of energy. The energy may be an electric energy. The energy may be fluid under pressure. The fluid may be air. The fluid may be a hydraulic fluid.

The driving pulley may be mounted on the output portion of the drive. The driving pulley may be mounted on its own spindle (shaft) and connected to the output portion of the drive with a coupling.

The endless component may be a chain. The endless component may be a belt. The endless component may be a cable. The endless component may be a wire.

The first rail extends along the first side of the conveyor and is mounted thereto in a fixed position. The first rail may extend an entire length of the conveyor. The first rail may extend a portion of the entire length of the conveyor. The first rail may be provided as a plurality of first rail portions. In other words, the first rail does not have to be a single continuous component.

The second rail extends along the second side of the conveyor and mounted thereto in a fixed position. The second rail may extend an entire length of the conveyor. The second rail may extend a portion of the entire length of the conveyor. The second rail may be provided as a plurality of second rail portions. In other words, the second rail does not have to be a single continuous component.

Each rail from first and second rails may be indirectly mounted to the conveyor with additional components. For example, each rail may be provided as an elongated component and may be disposed at a distance from the working surface with one or more brackets. The distance of the elongated rail from the working surface may depend on a size and/or shape of a product being conveyed. Thus, each rail may be used as a guide to guide the conveyance of the product along the flow direction. Each rail may be also used as a barrier or a guard to prevent an unintended movement of the product from the working surface and to further prevent the product from falling of the working surface.

The device may be designed with a first arm at one rail from the first and second rails, and with a second arm at another rail from first and second rails.

The first arm has a first end and a second end. The second end is positioned above the working surface mediate first and second sides. There is a fixed connection between the first end of the first arm and the first rail. There is also an adjustable connection between the second end of the first arm and the first rail.

The adjustable connection may be designed with an elongated component having one end attached to the first arm and having the second end threadably attached to the first rail, and a spring caged between the first rail and the first arm, the spring including at least a hollow interior sized to receive the elongated component therethrough. The adjustable connection designed to bias a product, conveying on the conveyor along the flow direction, toward the second rail.

The first arm may have two portions between the first and second ends. The portion that includes the first end may be positioned at an incline to the first rail. The portion that includes the second end may be positioned substantially parallel to the first rail. In other words, the first arm may be provided with a bend to define first and second portions.

The distance between the second portion (with the second end) and the opposite second rail is sized to be about the width of the product.

The second arm has a first end and a second end. The second end of the second arm is positioned above the working surface mediate the first and second sides. The second end of the second arm is positioned to rotate the product after a contact between the product and the second end of the first arm. There is a fixed connection between the first end of the second arm and the second rail. The second arm may be a straight component. The second arm is positioned at an incline relative to the second rail. The first end of the second arm is positioned adjacent the second end of the first arm.

Either fixed connection may be of a permanent or a releasable/detachable type, as described above.

In view of the above, the second end of each arm is positioned above the working surface. In view of the above, the second end of each arm is disposed at a distance from a respective rail in a direction toward the opposite rail. In view of the above, the device may be designed to change orientation of the product conveying on a conveyor.

In operation, the product conveying on the working surface contacts the inclined portion of the first arm that biases the product toward the second rail. Then, the product contacts a surface of the second arm that biases the product toward the first rail. The force of other products behind the product causes the product to rotate at the second end of the second arm. Thus, the orientation of the product on the conveyor changes after the product passes the second end of the second arm.

An apparatus may be designed with a conveyor, a clamp, a first sensor, a first device, a second sensor, a second device, and a third device.

The conveyor may be the conveyor as described above.

The clamp may be positioned adjacent an inlet end of the conveyor. The clamp may be designed to temporarily restrain a movement (conveyance) of the product on the working surface along the flow direction. The clamp may be designed to selectively apply a force to the product and release the application of force from the product. The clamp may be referred to as a product clamp.

The first sensor may be positioned adjacent the clamp along the flow direction, the first sensor designed to sense a first condition of the product and output a first signal in a response to sensing the first condition. The first condition may define an empty product. The first condition may define a product with a missing top. The first condition may define an open product. The first condition may define an inclined product. The first condition may define an incorrect type of the product. The first condition may define an incorrect size of the product. The first condition may define dissimilar products. The first condition may define a wrong orientation of a label on a side surface of the product. The first condition may define a missing label on a side surface of the product. The first condition may define an incorrectly applied label on a side surface of the product.

When first sensor senses the first condition, the first sensor may output a signal to be used by the clamp and/or a control device connected thereto to at least temporarily restrain conveyance of the products behind the product with the first condition.

The product may be a beverage product designed to be capped with a cap and wherein a first condition defines a wrong cap.

The first device may be designed to remove the product from the conveyor in a response to a receipt of the first signal. The first device may be designed with a linear actuator to move the product in a direction being normal to the flow direction. A collection device may be then positioned opposite the first device. The collection device may be a bin with an open top. The collection device may be a crate with an open top. The collection device may be a carton with an open top. The collection device may be a case with an open top. The collection device may be a tray. The collection device may be a dolly. The collection device may be a pallet.

The second sensor may be designed to sense a second condition of the product and output a second signal in a response to sensing the second condition of the product.

The second condition may define a wrong orientation of the product. The second condition may define a product that is rotated in a relationship to pother products. The second condition may define a product that is laying on its side rather than being erect. The second condition may define a product that has not been correctly manufactured.

The clamp may be also responsive to a receipt of the second signal to at least temporarily restrain conveyance of the products behind the product with the first condition.

The second device may be positioned adjacent the second sensor along the flow direction. The second device may be designed to change the second condition of the product in a response to a receipt of the second signal. The second device may be provided as an above described device designed with two arms to change orientation of the product conveying on the conveyor.

The second device may be also designed with another conveyor positioned substantially parallel to the conveyor, a connection between the conveyor and each end of the another conveyor, a rail mounted adjacent one end of the another conveyor for a movement between a first direction enabling a movement of the product in a flow direction and a second direction diverting a movement of the product onto the another conveyor, an actuator connected to the rail, the actuator designed to move the rail between first and second directions, and a rotating star-shaped wheel mounted to contact the product moving on the another conveyor and rotate the product in a horizontal plane.

A control device may be also provided and designed with components electrically connected therebetween to at least respond to at least one of the first and second signals and control operation of the at least one of the first and second devices.

The apparatus may be further adapted with a rail disposed along an edge portion of the conveyor, the rail configured to adjust the working width of the conveyor.

The third device may be provided as a device adapted to adjust the working width of the conveyor, as described above.

The clamp may be designed with a first component, a second component positioned at a distance from the first component, the distance sufficient to pass the product therethrough, and an actuator connected to one component from first and second components to pivot the one component toward to other component from the first and second components in a response to a receipt of a first control signal and pivot the one component away from the other component in a response to a second control signal. The actuator may be of the type as described above.

The clamp mat be designed with a linear actuator operable to cage the product between its moving portion and a fixed stop on the conveyor.

The apparatus may be designed with a conveyor, as described above, a sensor designed to sense a condition of the product and output a signal in a response to sensing the condition of the product, and a device positioned adjacent the sensor, the device designed to change the condition of the product in a response to a receipt of the signal.

The condition may define a wrong orientation of a label on a side surface of the product. The condition may define a missing label on a side surface of the product. The condition may define an incorrectly applied label on a side surface of the product.

The apparatus may be designed with a first component, a second component positioned at a distance from the first component, the distance sufficient to pass the product therethrough, and an actuator connected to first and second components, the actuator designed to pivot the first and second components toward each other in a response to a receipt of a first control signal and pivot the first and second components away from each other in a response to a second control signal.

The apparatus may be designed with a conveyor, as described above, a clamp disposed adjacent the inlet end, the clamp designed to temporarily restrain a movement of the product, a sensor designed to sense a condition of the product and output a signal in a response to sensing the condition of the product, and a device positioned adjacent the sensor, the device designed to change the condition of the product in a response to a receipt of the signal.

The apparatus, as described above, may be adapted with another sensor positioned adjacent the clamp along the flow direction, the another sensor designed to sense another condition of the product and output another signal in a response to sensing the another condition; and another device designed to remove the product from the conveyor in a response to a receipt of the another signal.

The apparatus (conveyor), as described above may be adapted with a device for a product that has fallen (tipped) from a vertical position, to a horizontal position (i.e. the product is laying on one of its sides).

The device may be designed, with a clamp, to hold back the containers advancing behind the fallen container, to stop the fallen container, and rotate the container to a vertical position. The device may be designed with a pivoting arm that is positioned below the product and nests the product into another component, that may be a stop or a stationary mounted component, that captures and stabilizes the product, prior to releasing the product, and releasing the product that was behind the fallen product. The device may be referred to as a product lifter.

The device may be designed with an arm to rotate a product to a desirable orientation, that can “scope” up or down, i.e. move in a vertical direction, so that products of similar profile, but of different height, can be oriented with the same device, by way of raising or lowering the orientation device.

The device may be designed with an arm to rotate a product to a desirable orientation, that can “scope” in and out, i.e. move in a horizontal direction, so that products of different profile, but of same height, can be oriented with the same device, by way of moving inward and outward, horizontally, the orientation device.

The device may include an adjustable component to accommodate products of different sizes and/or of different profiles (shapes).

The device may be biased toward one side of the conveyor, and there may be need for a linear actuator, or other device, to push the product horizontally onto the rotating device, and keep the product engaged with the rotating device. This feature may be used where the product is narrower than the conveyor, with the rotating device being mounted alongside the conveyor adjacent one side thereof.

The actuator may be positioned above the product and adapted with a suction cup to engage a surface portion of the fallen container and lift such fallen container into the vertical orientation.

The actuator may be positioned above the product and adapted with a gripper arrangement to grip a portion (for example opposite sides or a gable top) of the fallen container and lift such fallen container into the vertical orientation.

This device may be referred to as a product lifter. This device may be referred to as a product lifting device. This device may be referred to as an apparatus. This device may be referred to as a product lifting apparatus.

In view of the above, a method may include steps of sensing, with a sensor, a condition of a product advancing on a conveyor, energizing, with a control unit in a response to a signal from the sensor, a linear actuator, and pivoting, with the actuator, an arm being in a contact with the product.

In view of the above, a method may include steps of sensing, with a sensor, a condition of a product advancing on a conveyor along a flow direction, energizing, with a control unit in a response to a signal from the sensor, a first linear actuator, moving, with the first linear actuator, the product in a first direction being normal to the flow direction, energizing, with the control unit in the response to the signal from the sensor, a second linear actuator, pivoting, with the second linear actuator and an arm being pivotally attached to the second linear actuator and being in a contact with the product, the product from a first orientation into a second orientation, energizing, with the control unit in the response to the signal from the sensor, a third linear actuator, and moving, with the third linear actuator, the product in a second direction, the second direction being opposite to the first direction.

Either of the methods may include additional steps of energizing, with the control unit in the response to the signal from the sensor, a fourth linear actuator, and temporarily terminating, with the fourth actuator, an advancement of other products advancing on the conveyor downstream from the product being pivoted.

In view of the above, a method may include steps of sensing, with a sensor, a condition of a product advancing on a working surface of a conveyor, energizing, with a control unit in a response to a signal from the sensor, an actuator, and moving, with the actuator, the product of the working surface.

In view of the above, a method may include steps of sensing, with a first sensor, a first condition of a product conveying on a conveyor along a product flow direction, moving, with a first device, the product in a response to the first condition, sensing, with a second sensor, a second condition of a product conveying on a conveyor along a product flow direction, and moving, with a second device, the product in a response to the second condition. Sensing of the first condition may include sensing one of a presence and an absence of a product top. Sensing of the second condition may include comprises sensing one of a presence and an absence of a product label. Moving the product with the first device comprises may include moving the product from the conveyor. Moving the product with the second device comprises may include rotating the product.

Moving the product with the second device comprises may include changing an orientation of the product.

The apparatus, as described above, may be adapted with a product rotation device, resembling an 8-sided star-shaped wheel. The star-shaped wheel may be designed as a device with one or more flat or contoured planes, to receive product(s) or cases, or pallets, and turn the intended item into an alternate rotation. This does not mean that the device is in the shape of a star, but rather that it could resemble one or more star shapes, but is not limited to the shape of a star.

The star-shaped wheel can have one or more “pockets” to receive and rotate products from one orientation, to another orientation.

The star-shaped wheel can be powered, or a non-powered. Powered star-shaped wheel may include a “motor” with direct drive, or indirect drive (which could include a slave system, such as two, or more, sprockets with a continuous or segmented chain; or two or more sheeves, with a continuous or segmented belt); motor can be electric, hydraulic, pneumatic, servo, or other.

The star-shaped wheel can be inline and over one conveyor.

The star-shaped wheel may be positioned in line with a conveyor and transfer product to an adjoining conveyor.

The star-shaped wheel may swing, or advance, from an external position of the conveyor, to an internal position of the conveyor, acting as a stop, or creating the rotation of the product or another function.

The adjoining conveyor can be set at a different speed, to assist with rotation. The adjoining conveyor could have line control that includes a fixed speed, or alternate speed, controlled by a means such as a variable speed controller, or modulating valve.

The star-shaped wheel may be mounted to a conveyor, or independently supported.

The star-shaped wheel may be different thicknesses, or multiple layers, or multiple contours.

The star-shaped wheel could be mounted on a shifting member, such as a plate or air slide, and can be moved in and out with a cylinder (such as hydraulic, or pneumatic), or a servo type of movement (such as a belted drive with encoder, or linear actuator), and the star can be moved in to rotate a single object in a row of objects, if the single object is in a wrong orientation.

The movement of the center position of the star-shaped wheel may be incorporated with a clamp.

The movement of the center position of the star-shaped wheel may be to accommodate a fallen product that would not nest correctly.

The star may be incorporated with a device positioned prior to the star-shaped wheel and designed to remove products out of compliance or preset specifications (missing cap, crushed or damaged, one of two or more products that may travel on the line that do not require the star-shaped wheel).

The apparatus, as described above, may be adapted with a device designed with a component positioned, in a fixed arrangement, to encroach a path of the product so that the product would rotate upon a contact with the component. The component may be any one of a round bar, a square bar, a rectangular bar, any fixed position item, made of many different types of materials. The component may be also any one of a shaft, with a wheel, or a bearing (with a wheel mounted on it, or a foam roller, or plastic roller), that will “break friction” as the product, or container, or pallet rotate around the face. The component could move from one position to another position, to selectively rotate or turn one or more items out of several items travelling together.

This device may be referred to as a “bump turner”.

The “bump turner” may swing, or advance, from an external position of the conveyor, to an internal position of the conveyor, acting as a stop, or creating the rotation of the product or another function.

The apparatus may be adapted with an inline solution designed with cascading fingers that are arranged in an arrangement of progressively longer “fingers”, contoured on their end, to equal a continuous plane, to remove the product from the conveyor onto an accumulation table. The fingers can rotate downward into position as the product is travelling, and after the product passes each finger, the finger can move back upward, so products can be removed as they travel, and not require products behind the product being moved to be stopped or clamped.

The accumulation table can be automatic, or can move based on the product entering onto the accumulation table, or fixed position.

The apparatus may be adapted with a transfer conveyor used for a conveying line control, or to break up the length of a conveyor, to widen a conveyor at a turning product point, for slowing and speeding conveying lines independently.

The apparatus may be adapted with a guide rail turner designed with a fixed or moveable rail that a product may contact with, and as the product travels along the rail, the rail corrects the orientation of the product. This can be demonstrated in an example of a gable top carton. Gable top carton have a single plane in the middle of the carton, oriented at the top, and in the middle of the carton. If the carton is in a correct orientation, and the gable is conveying “in-line” and parallel to the direction of conveyance, the rail may protrude over a spanned distance from an edge toward the middle, and the gable may only make contact at the end point of the rail, when the rail ends (in the middle of the conveyor). However, a perpendicular carton as it conveys will have the gable, on the starting point of the rail, begin to make contact, and as the carton continues to travel the carton begins to rotate with the friction of the edge of gable, until the carton is conveying parallel to the rail until re-oriented with the gable in the correct direction (parallel with the direction of conveyance).

The rail may be adjustable, manually or automatically, to accommodate one or more products travelling on the same conveyor.

The rail can be moved manually or automatically on a vertical plane, a horizontal plane, or an angled plane.

The manual movement may be through an adjustable screw, an adjustable nob that may move a capturing port, a pivoting member on a hinge, a guided member with a clamp or set screw, or collar.

The automatic movement could be provided by way of a cylinder (air or hydraulic), a servo operated system (belt and motor with encoder, or linear actuator) or other method that can have a drive, or solenoid, or other controlled method.

The control unit may have a human to machine interface, such as a touch screen, or a readable digital screen. The interface may be programmed with a specific function, multiple functions, or multiple “recipe's”, such as sequences of logic based on one or more product types. The control unit may communicate with other equipment upstream or downstream, such as an output signal to be used by other equipment, or energize a light or horn, or other device for communicating/communication. The control unit may have a circuit that sends a signal that can enable or disable another machine(s), an interlock.

A remote control/operator panel may be used exclusively, or in cooperation with a local panel, or series of machines, to operate the device described above.

The apparatus, as described above, may have adjustable rails. The rails may be of a swinging type, that can be powered (by power, air, or hydraulic), or a manual application (that may require a pin, or latch, or other limiting device).

A conveyor that conveys multiple products of multiple sizes may have a setpoint or width for the “largest” product. It may be desired to restrict the discharge conveyor, from the device being described above, after the quality and control functions are complete, for the duration of the travel of the product (this can be a function for a rail that may have to be narrowed for a significant distance, and could be very costly; this method, of orienting a product before or at a caser eliminates the expense of controlling an entire line, and only controlling a short(er) distance of conveyor).

The adjustable rail may be also provided as a hinged rail, or drop in rail, or tilting rail, or laterally moved rail, or lowering rail, all of which can be automated or manual configurations.

Other control devices for alternate or mentioned functions include photo eyes (such as two photo eyes in a vertical configuration to each other, where a product that is taller than it is wide, when the product is vertical the two photo eyes read a correct orientation, or when a product has fallen over, the lower photo eye will “see” the product and the upper photo eye will not, and demonstrating a container has fallen.

An optional photo eye or proximity switch that can sense a “flag” that might me mechanically moved by a product in an incorrect orientation, which would send a signal demonstrating a condition out of the programmed specification.

A combination of sensors, such as a photo eye and a proximity switch, where a photo eye may sense the neck of a capped container, and when the cap is missing, a proximity switch may sense that there is not cap; and in communication with each other (via a setting or program or relay, or other) may demonstrate a condition out of specification.

Sensors working within and complimenting the operation of the apparatus described above include photo eyes, proximity switches, limit switches, air sensors, light curtains, laser sensors, scanners, ultrasonic, or other.

The device, apparatus and method, as described above, may be used to detect a condition of open cartons or jugs and correct such condition.

The device, apparatus and method, as described above, may be used to detect a condition of turned cartons or jugs (wrong orientation; can be for label direction issues, or gripper orientation issues, or other reason) and correct such condition.

The device, apparatus and method, as described above, may be used to detect a condition of tipped cartons or jugs and correct such condition.

The device, apparatus and method, as described above, may be used to detect a condition of incorrect product size and correct such condition.

The device, apparatus and method, as described above, may be used to detect and correct a quality control issue such as a wrong label or missing label and correct such condition.

The device, apparatus and method, as described above, may be used to detect and correct a quality control issue such as a poorly applied label.

The device, apparatus and method, as described above, may be used to detect and correct a quality control issue such as a wrong cap (color or sticker or other).

The device, apparatus and method, as described above, may be used to detect and correct a quality control issue such as a poorly sealed gable top (an alarm can sound back to filler operator).

The device, apparatus and method, as described above, may be used to detect and correct a quality control issue such as a wrong product mixed with other similar product (red carton mixed with blue carton).

The device, apparatus and method, as described above, may be used to detect and correct a condition of empty filled carton that looks full, but not observably empty.

The device, apparatus and method, as described above, may be used to detect and correct a condition of short filled carton that looks full, but not observably partially filled.

The device, apparatus and method, as described above, may be used to detect and correct a condition of backed up equipment line (that can be alarmed or automate conveyor shutdown in sequence, or both)

The device, apparatus and method, as described above, may be used to detect and correct a condition of product present but caser not operating.

The device, apparatus and method, as described above, may be used to detect and correct a condition of a product break (to hold back pressure of additional incoming product).

The device, apparatus and method, as described above, may be used to detect and correct a condition of width of area containers travel (if various dimensions).

The device, apparatus and method, as described above, may be used to detect and correct a condition of height of area containers travel.

The device, apparatus and method, as described above, may be used to turn products to correct orientation.

The device, apparatus and method, as described above, may be used to remove undesired products.

The device, apparatus and method, as described above, may be used to divert similar or dissimilar products that share a common conveyor.

The device, apparatus and method, as described above, may be used to divert products from one line to two lines.

The apparatus, as described above, may be mounted alongside an existing conveyor, or may be positioned inline of an existing conveyor.

The apparatus, as described above, may use an existing conveyor transportation (such as belt, or chain, or indexer, or other), or may have its own product transportation method (similar or dissimilar).

The apparatus, as described above, may be driven from another method of product movement (“slave” driven).

The apparatus, as described above, may be mounted above an existing conveyor, not requiring a frame of it's own.

The apparatus, as described above, may be pre-assembled, or assembled onsite.

The apparatus, as described above, may require power (such as 110v) or other utilities (such as pneumatic, hydraulic, servo, or other).

The apparatus, as described above, may have an on/off mode with simple to no control, or could have control items such as a variable speed drive, or modulating cylinder (in one or more applications), utilize servo motion or encoder motion (such as a belt drive).

The apparatus, as described above, may be used to move bad dairy cases off of a line, before the go into a stacker, because bad cases, when positioned at the bottom of a stack, will cause the stack to fall over, stopping one or more lines, a lot of clean-up, lost product, and lost productive manpower, toward a mitigatable condition.

The apparatus, as described above, may be used to sense a case in an incorrect orientation and correct the orientation.

The apparatus, as described above, may be used to sense a damaged case, with one or more sensors that are designed to determine a damaged case. In an example, a scanner may be programmed with a shape and surface features of the case and determine flaws like a fracture, a crack, and/or a missing portion of the case. This damaged case may be then removed from the conveyor so as to not affect an integrity of a stack of nested cases and/or integrity of products during transport, should the damaged case be included.

Identifying and removing damaged cases may improve product throughput by minimizing conveyor stoppages to remove damaged boxes either manually or with an aid of devices that have to be moved to and from conveyor.

The apparatus, as described above, may be used to sense a case that is not fully loaded with product.

No one is doing this.

The only solutions today are stopping every case, and using, to identify cracked cases.

The apparatus, as described above, may be used to prevent products, that are out of specification or compliance, from entering any one of a caser, or a loader, a stacker, a palletizer, a dolly loader, a tray casing system (could be wrap around tray, or wrap around box), a film system where a plastic film fully, or partially, encapsulates a plurality of products, including by a shrink wrap process or other place that may jamb.

The apparatus, as described above, may be used to improve operation of the packaging plants by at least minimizing if not completely eliminating packaging interruptions due to improperly orientated, and/or poorly formed/sealed cartons, and/or bad cases.

The apparatus, as described above, may be positioned upstream of a product caser.

The apparatus, as described above, may be positioned upstream of a container loader.

The apparatus, as described above, may be positioned upstream of a box loader.

The apparatus, as described above, may be positioned upstream of a shrink wrap machine.

The apparatus, as described above, may be positioned upstream of a tray sized to receive the product therewithin. More than one product may be received within the tray.

The apparatus, as described above, may be positioned upstream of a dolly.

The apparatus, as described above, may be positioned upstream of a slip sheet (tier or pallet).

Now in a reference to the drawings.

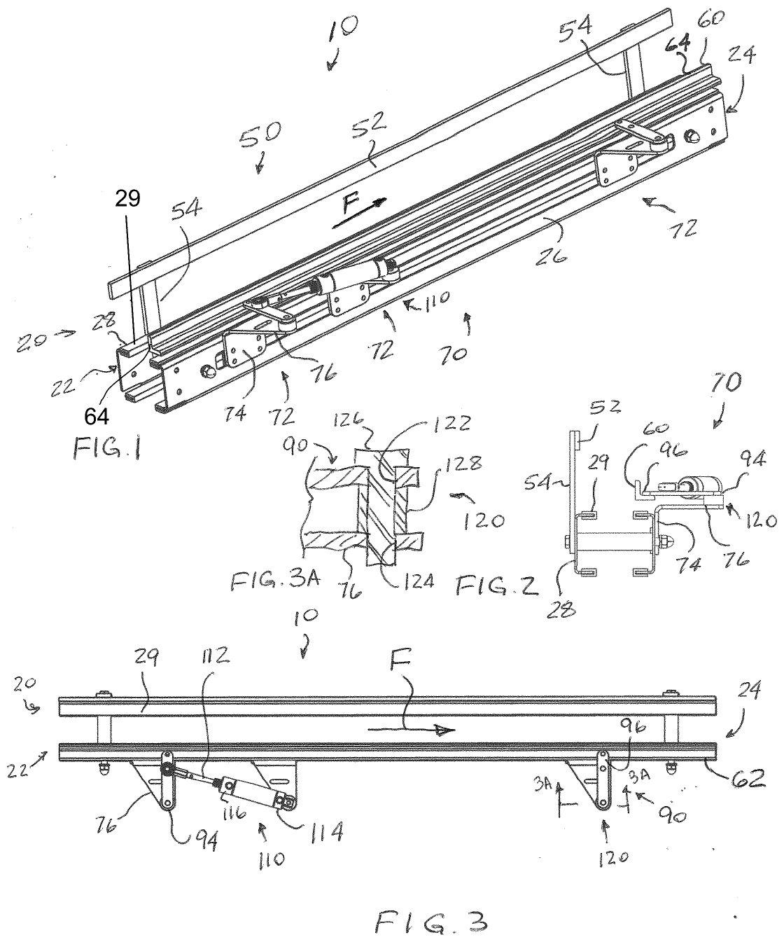

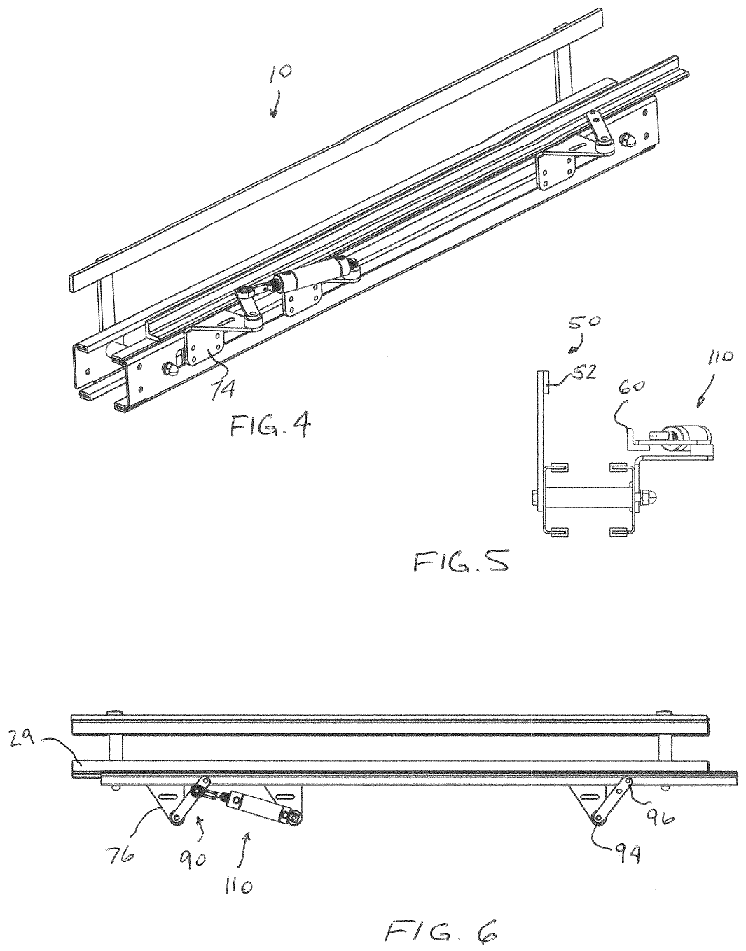

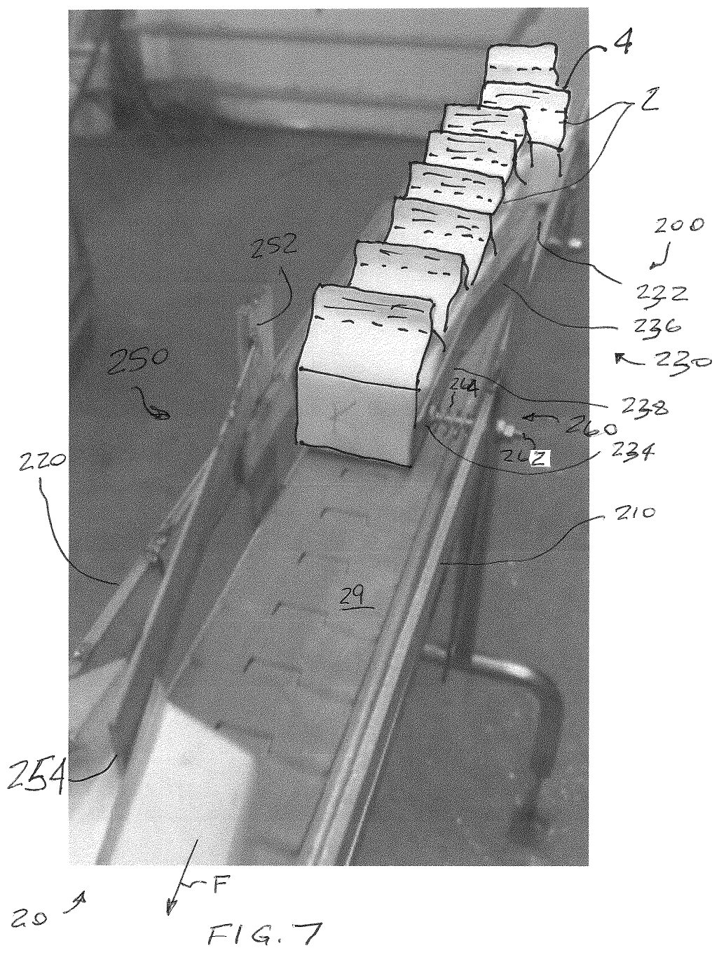

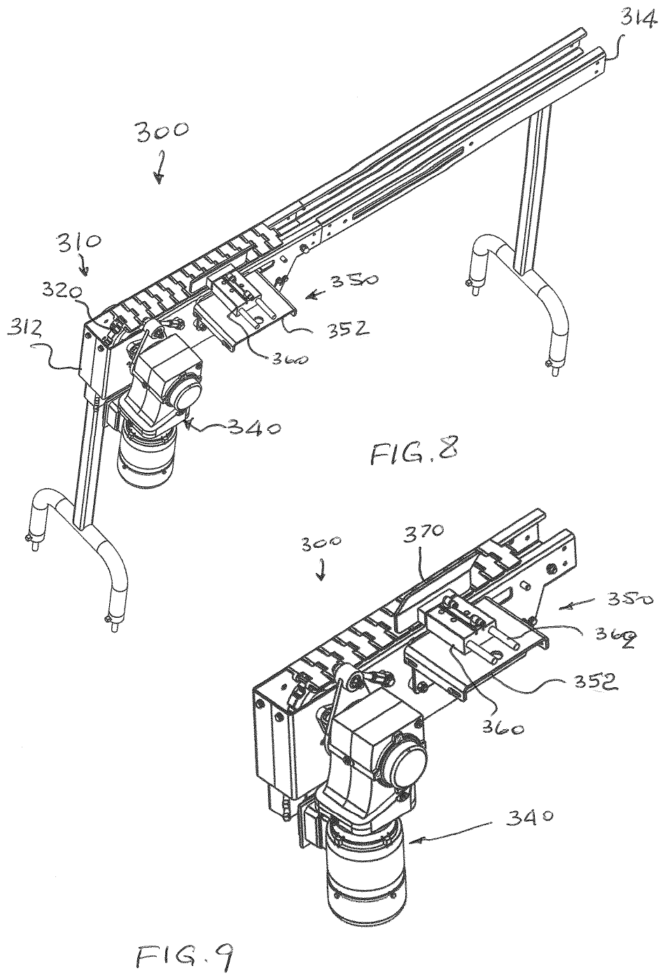

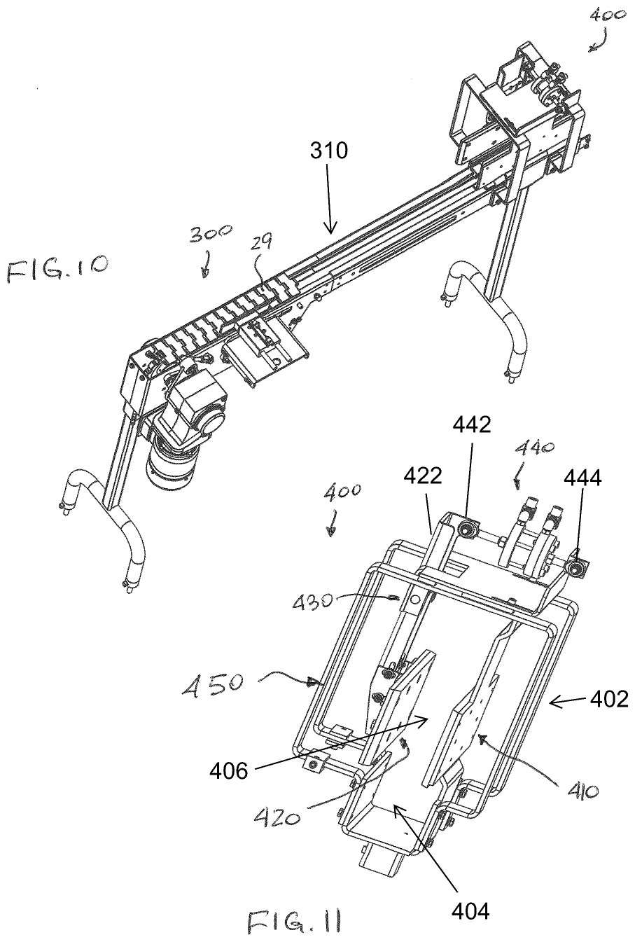

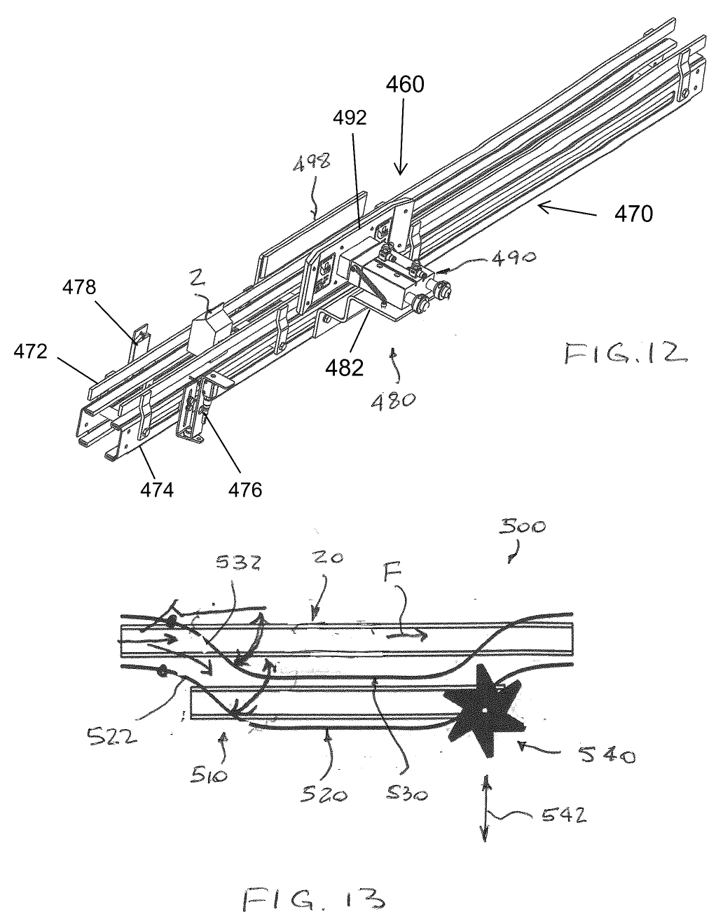

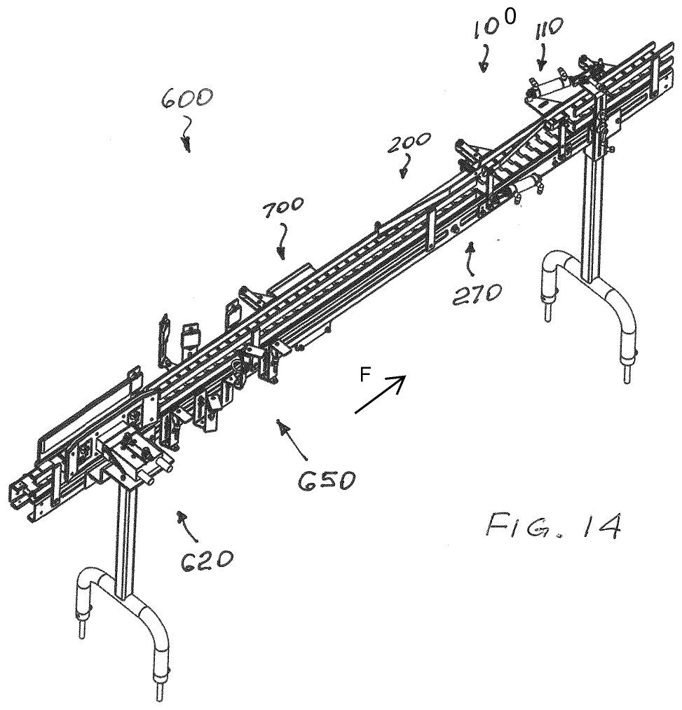

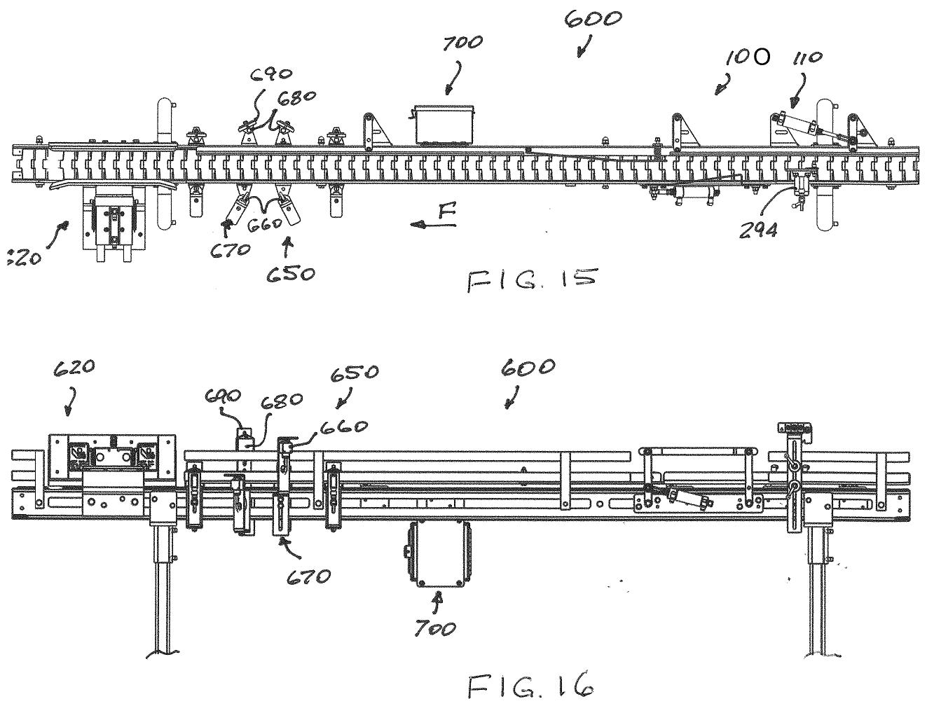

FIG. 1 illustrates one perspective view of a device 70 designed to adjust a working width of a conveyor 20. The device 70 and the conveyor 20 may be also referred to as an apparatus 10.

The conveyor 20 is illustrated with a first end 22, a second end 24 disposed opposite the first end along a length of the conveyor 20, a first side 24 between first and second ends, 22 and 24 respectively, a second side 28 opposite the first side 26 across a width of the conveyor 20, and a working surface 29 between first and second ends, 22 and 24 respectively. The first side 26 and the second side 28 are illustrated as having a C-shaped configuration in a plane normal to the length of the conveyor 20. A conveyor drive is not illustrated in FIG. 1 for the sake of clarity. The working surface 29 is provided by a partially illustrated endless component of the conveyor 20. The distance between the first and second ends, 22 and 24 respectively, defines a flow direction F.

A first rail 50 is illustrated as an elongated component 52 being positioned adjacent the second side 28 and upstanding above the working surface 29 with at least one component 54. The quantity of components 54 may depend on the length of the conveyor 20 with a longer conveyor needing two or more components 54. Although components 52 and 54 are illustrated as components with two flat surfaces and uniform thickness, other shapes may be used. A longer conveyor 20 may need additional stiffening of the elongated component 52. The stiffening may be provided by an L-shaped elongated component. The stiffening may be provided by additional components 54.

The second rail 60 is illustrated in FIG. 1 as an L-shaped component with a first leg 62 and a second leg 64.

The device 70 is illustrated with three brackets 72 and two arms 90 may define a guide 100. Each bracket 72 is illustrated as an L-shaped component with a first leg 74 and a second leg 76. Each arm 90 is illustrated with one end 94 and an opposite end 96.

The device 70 is further illustrated with an actuator 110. The actuator 110 is illustrated as a cylinder.

The actuator 110 is illustrated in a pivotal connection with one arm 90 and each arm 90 is being illustrated in a pivotal connection with a respective bracket 70.

Position of the first rail 50 and the second rail 60 may be reversed in a relationship to a side of the conveyor.

FIG. 2 illustrates a view of the apparatus 10 from the inlet end 22 of FIG. 1. The second rail 60 is positioned in FIG. 2 over the working surface 29 and biased toward the rail 50. Such position may be referred to as a first position. Such position may be referred to as a position that reduces an effective working width of the conveyor 20. A pivotal connection 120 is also illustrated and will be explained in details in FIG. 3A.

FIG. 3 illustrates a top view of the apparatus 10 of FIG. 1. The actuator 110 is illustrated as a cylinder with a rod 112, a rod end 116 and a cap end 114. The rod 112 is pivotally connected to the conveyor 20 through one bracket 72 and to the second rail 60 through one arm 90. Two brackets 72 are connected to the conveyor 20 and to the second rail 60 with the arms 90.

FIG. 3A illustrates a partial cross-sectional view of a pivotal connection along lines 3A-3A in FIG. 3. One (first) aperture 122 is provided through a thickness of the arm 90. Another (second) aperture 124 is provided through a thickness of the leg 76. The pin 126 is inserted through both apertures. An optional spacer 128 is also illustrated. Other pivotal connection types may be used. In an example, a shoulder bolt can threadably engage one of the leg 76 and the arm 90 and also provide a function of the spacer 128.

FIG. 4 illustrates another perspective view of the apparatus 10 of FIG. 1 with reference numerals removed for clarity.

FIG. 5 illustrates an end view of the apparatus of FIG. 4. The rail 60 is illustrated as being in a second position, being biased away from the rail 50. Such position may be referred to as a position that increases the effective working width of the conveyor 20.

FIG. 6 illustrates a top view of the apparatus of FIG. 4. In view of the above, the actuator 110 moves the rail 60 between the first and second positions through the arms 90. It should be noted that a second actuator 110 may be connected to the second arm 90 in FIGS. 1-6.

FIG. 7 illustrates a perspective view of an apparatus 200 adapted to change an orientation of a product 2 conveying on the conveyor 20 along the flow direction F. The product 2 is lustrated as a carton container with a gable top 4. A first arm 230 is illustrated with a first end 232 attached to one rail of the conveyor 20 and with another end 234 disposed over the working surface 29. The first portion 236 and the second portion 238 define a bent shape of the first rail 210. The second arm 250 is illustrated as a straight component with a first end 252 attached to another rail of the conveyor 20 and with another end 254 disposed over the working surface 29. The adjustable connection 260 is illustrated with a pin (elongated component) 262 and a spring 264. The apparatus 200 may be designed to turn the carton container 2 so that the gable top 4 is oriented in a direction of flow F, rather than being oriented perpendicular to the direction of flow F, as is illustrated in FIG. 7.

FIG. 8 illustrates a perspective view of an apparatus 300 with a conveyor 310 and a device 350. The conveyor 310 may be the conveyor 20 as described above. In addition to the components of the conveyor 20 illustrated in FIGS. 1 through 6, FIG. 8 illustrates a driving pulley 320 at the inlet end 312. The driving pulley 320 is connected to and driven by the drive 340. The device 350 is illustrated with a linear actuator 360 supported on the component 352 that is attached to the conveyor 310. The device 350 is positioned to move the product 2, traveling between the ends 312 and 314, from the working surface of the conveyor 310 in a response to a signal. In other words, the device 350 may be commanded to remove or “punt” the product from the working surface when the condition of the product has been determined as being out of compliance.

FIG. 9 illustrates an enlarged partial perspective view of the apparatus 300 of FIG. 8. The linear actuator 360 slides on the slides 362 to move a component 370 across the working surface 29. The stroke of the linear actuator 360 is designed to move the product 2 through a contact with the component 370 at least a distance sufficient for the product 2 to fall of the working surface 29.

FIG. 10 illustrates a perspective view of the apparatus of FIG. 8 with an optional clamp 400, whose design will be explained in details in FIG. 11.

FIG. 11 illustrates an enlarged perspective view of the clamp 400 of FIG. 10. A mounting component 402 is illustrated as being designed for direct or indirect attachment to the conveyor 310 passed through a gap 404 so that the product 2 would be position in a space 406 between a first component 410 and the second component 420. The first component 410 is illustrated as a fixed component. The second component 420 is illustrated as a pivoting component at the pivot 430 with the mounting component 402.

One end of an actuator 440 is connected to an arm 422 extending from the second component 420 to move the second component 420 toward to and away from the first component 410. The connection 442 between the actuator 440 and arm 422 may be a pivotal connection. The other end of the actuator 440 is pivotally connected to the mounting component 402 at another pivot 444. The mounting component 402 is illustrated as at least two mounting components 450 to reduce weight of the device 400.

The product 2 is conveyed through the space 406 between the first component 410 and the second component 420. When the second component 420 is pivoted toward the first component 410, the product 2 is essentially restraint between these two components and a conveyance of the product 2 is at least temporarily terminated.

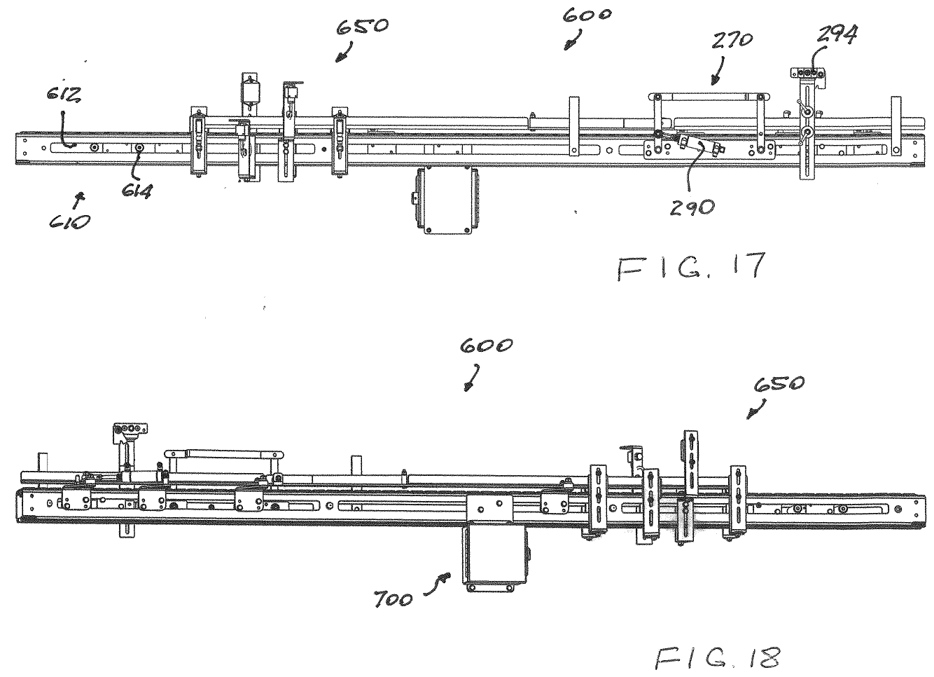

FIG. 12 illustrates a perspective view of an apparatus 460 that at least includes a conveyor 470 with and an optional product clamp 480. The conveyor 470 may be of any type as described above. The product clamp 480 may include an actuator 490 that is of a linear type and that may be provided as the above described actuator 360. The actuator 490 may be attached to the support 482 that is in turn attached to the conveyor 470. In other words, the actuator 490 is indirectly attached to the conveyor 470. The support 482 may upstand next to the conveyor 470 without being attached thereto.

A stop 498 is illustrated as being fixed to the conveyor 470 opposite a component 492 of the actuator 490. The product advances on the conveyor 470 between side rails 472 and 474. When the conveyance of the product 2 on the conveyor 470 is to be at least temporarily stopped, the actuator 440 Is operated from a source of energy to move the component 492 toward the stop 498 and essentially clamp the product 2 therebetween.

Optional sensor 476 and a target 478 are also illustrated.

FIG. 13 illustrates a diagram of an apparatus 500 that is adapted to move the product 2 onto a secondary conveyor 510 and to further turn or rotate the product with a star shaped wheel 540 that is attached to a power-operated actuator (not shown). Secondary rails 520 and 530 are also illustrated. Rail portions 522 and 532 are designed to selectively pivot based on control and sensing depending on whether or not an orientation of the product 2 conveying on the conveyor 20 needs to be changed.

The star shaped wheel 520 may be designed to move along a direction 542 so as to selectively contact the product 2. In this design, all products 2 may be conveyed on the conveyor 520, with the star shaped wheel 540 being selectively moved to turn or rotate the product 2.

The star shaped wheel 520 may be moved several times if the product 2 may need to be turned more than once.

More than one rotating and/or moving star shaped wheel 540 may be provided.

The secondary conveyor 510 may be an automated conveyor, as described above.

The apparatus 500 may be employed with any of the conveyors described in this document.

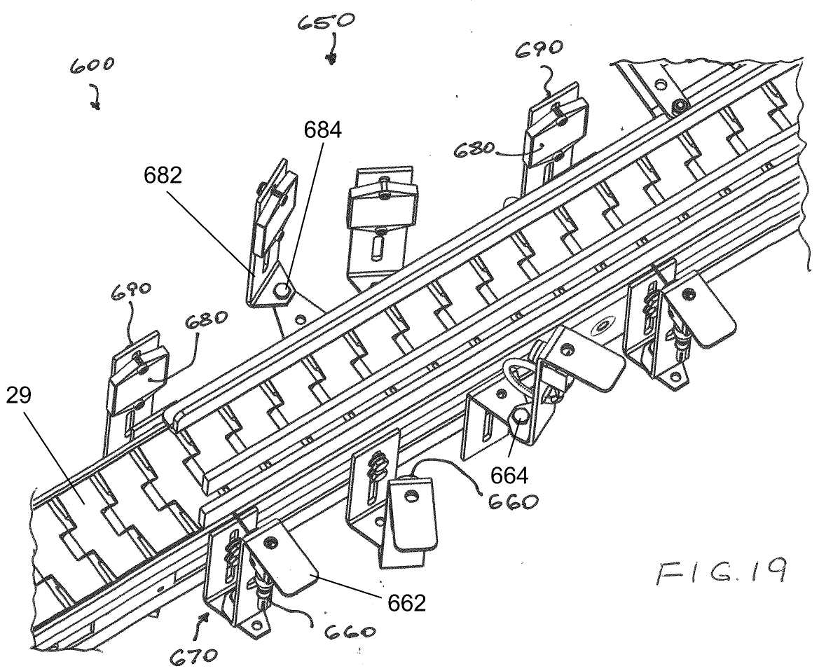

FIG. 14 illustrates a perspective view of an apparatus 600. The product clamp 620 is illustrated as being adapted with one device 480, although the above described devices 350 and 400 may be employed. The clamp 620 is positioned as an infeed clamp.

An optional sensor assembly 650 is illustrated as being positioned next to the product clamp 620. The above described guide 100 and apparatus 200 are also illustrated. A control unit 700 is illustrated as being attached to the frame of the conveyor. FIG. 14 also illustrates a second arm assembly 270 that will be described further in this document.

FIG. 15 illustrates a top view of the apparatus 600 of FIG. 14. The sensor assembly 650 is illustrated with sensors 660 mounted on brackets 670 and targets 680 mounted on brackets 690. When the sensor 660 is provided as a photo eye, the target 680 is provided as a reflector. The sensors 660 may be used to determine if the product is tipped over and is laying on its side. These (middle) sensors are illustrated as being disposed at an angle to the direction of the flow F. An output signal from these sensors 660 to the control unit 700 may cause the control unit 700 to terminate flow of the product 2 and may further cause the control unit 700 to sound alarm. Flow of the product 2 may be terminated by stopping the conveyor. The sensors 660 may be used to determine excessive back-up of the products 2. These (edge) sensors are illustrated as being disposed generally perpendicular (normal) to the direction of the flow F. An output signal from these sensors 660 to the control unit 700 may cause the control unit 700 to activate the product clamp 620 to temporarily stop flow of the product 2. The apparatus 600 may be designed with a sensor 660 to only indicated tipped products. The apparatus 600 may be adapted with a sensor assembly 650 designed to only indicated tipped products. The apparatus 600 may be adapted with a sensor assembly 650 designed to only indicated a backed-up product condition.

FIG. 15 illustrates that the product clamp 620 is positioned downstream of the conveyance path.

FIG. 16 illustrates an elevation view of the conveyor 600 of FIGS. 14-15.

FIG. 17 illustrates one partial elevation view of the apparatus 600 of FIG. 14. The product clamp 620 is omitted in this figure to expose a mounting or attachment arrangement 610 that is being illustrated as an opening 612 in a conveyor frame and one or more mounting components 614 that may be a threaded aperture or a threaded fastener.

FIG. 18 illustrates another elevation view of the conveyor of FIGS. 14-17.

FIG. 19 illustrates a partial perspective view of the apparatus 600 of FIG. 14, and more particularly, illustrates the sensor assembly 650 with sensors 660 mounted on brackets 670 and targets 680 mounted on brackets 690. It can be seen that the bracket 670 or 690 may be designed as an assembly with two or more components to allow mounting to the mounting components 614 and allow adjustability of the sensors 660 and/or targets 680. It can be also seen that the bracket 670, 690 may be made adjustable, at least in a vertical direction, by way of elongated slots and fasteners. Sensor 660 may be mounted on another bracket 662 with a pivotal connection 664 to the bracket 670. Another pivotal connection 684 may be employed to pivotally attach (target) bracket 682 to the bracket 690.

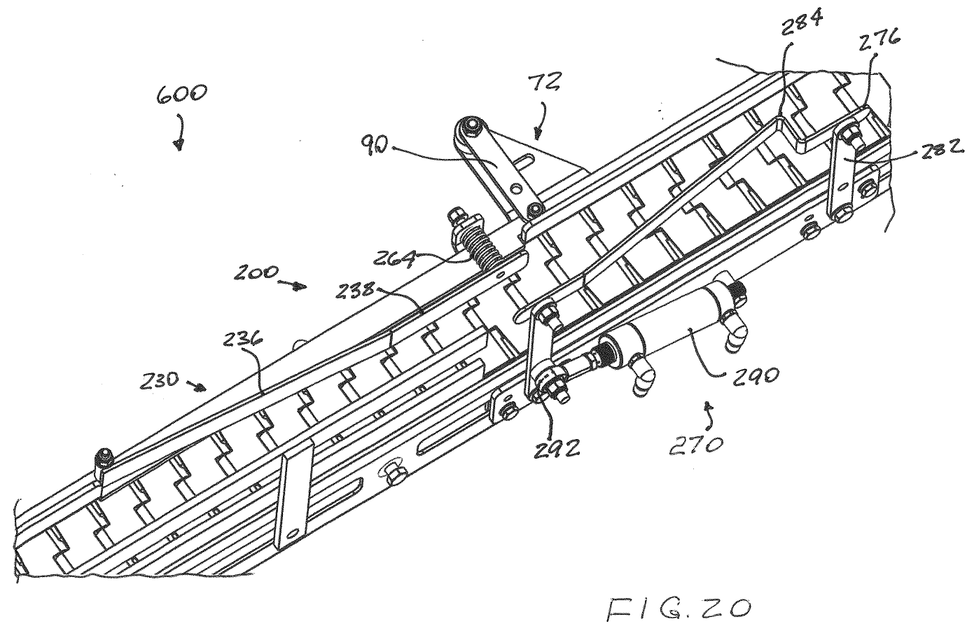

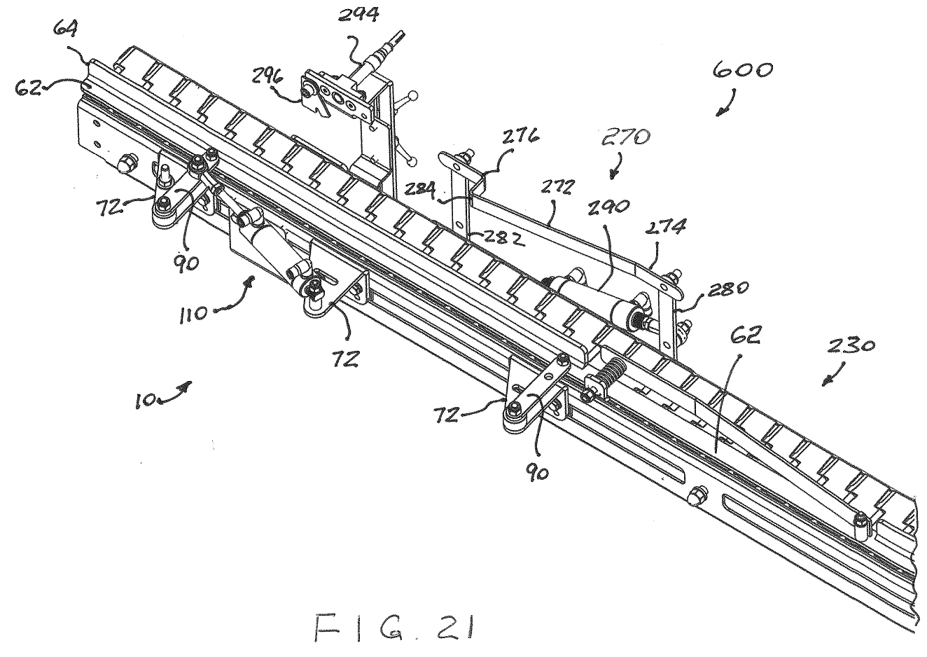

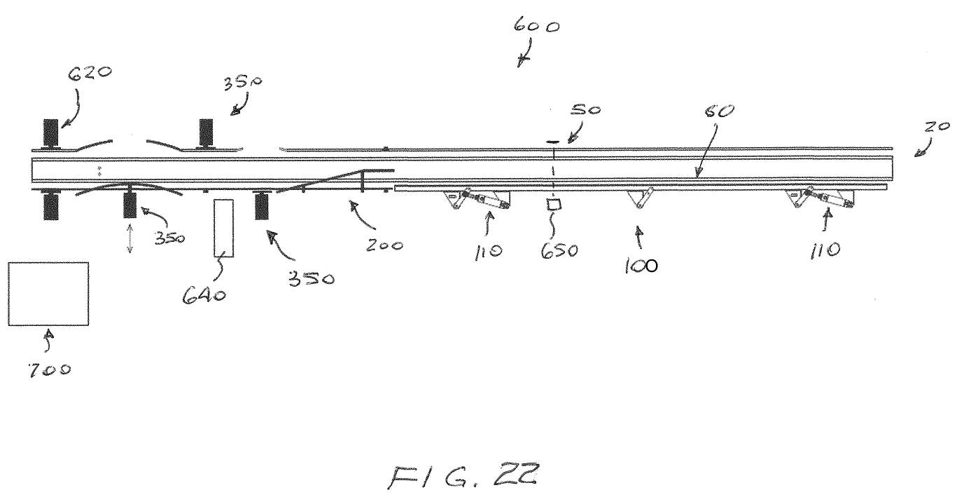

FIG. 20 illustrates a partial perspective view of the apparatus 600 of FIG. 14, and more particularly, illustrates a second arm assembly 270 that may be used instead of the second arm 250 of FIG. 7. The second arm assembly 270 may be designed with a second arm 272 that has a first end 274 and a second end 276. The first end 274 is attached (for example by way of fasteners) to a vertically disposed arm 280. The first end 274 is attached (for example by way of fasteners) to a vertically disposed arm 282. The second end 276 is designed as a generally Z-shaped offset with a transition 284 to a slopped portion of the second arm 272. The transition 284 causes turning motion of the product advancing along the slopped portion. A linear actuator 290, for example such as a cylinder, has a connection 292 with the arm 280 to accommodate products 2 of different heights. The transition 284 may be a bend without the generally Z-shaped offset.

FIG. 21 illustrates a partial perspective view of the apparatus 600 of FIG. 14, and more particularly, illustrates a sensor 294 that is positioned adjacent the second arm 272 to detect product 2 that did not change the orientation upon contacting the transition 284. In other words, if the orientation of the gable top 4 is still perpendicular to the direction of flow F, the arm 296 is designed to pivot, upon contacting the gable top 4 and obstruct view of the sensor 294. When the view is obstructed, the sensor 294 is designed to output a signal to the control unit 700 that may cause the control unit 700 to terminate flow of the product 2 and may further cause the control unit 700 to sound alarm.

FIG. 22 illustrates a diagram of the apparatus 600 that may be also referred to as a system. The product clamp 620 is illustrated as designed with two devices 350, although the above described devices 340 and 480 may be employed. Another device 350 is illustrated as positioned next to the product clamp 620. One or more devices 350 may be positioned downstream of the flow F to move the product 2. At least one sensor 640 is illustrated. The above described apparatus 100 and apparatus 200 are also illustrated.

The sequences of devices in FIG. 22 may be further described as these devices may appear in the direction of the infeed flow of products (for example from a product filler to a product caser, and as may be used in a dairy application):

A product clamp 620 to hold back up stream pressure and relieve such back pressure onto the product 2 downstream of the inlet end.

More than one product clamp 620 can be used in an application. A second clamp may be used to separate products with flat sides, for example such as products with flat sides, such as products that need to be turned, such as creating a gap, because flat sided products touching each other, can inhibit a movement of the product that may need to be turned. A third clamp may be used for a carton or jug reject, to hold back products not to be rejected (rejection devices described below).

One device 350 may be used as an empty product reject based on sensing of such empty product.

A scanner 640 may be of the type as manufactured by a Keyence Corporation of America in Brookfield, WI. This scanner has up to 50+ options of identification, and programmed for outputs based on what the scanner observes (such as operating a clamp, to make a gap, for a product to be turned, or a product reject.

The scanner 640 may be located in a position to scan a product 2 as well as seeing the product before or after the scanning station (such as seeing beyond a product turner; to view if a product did turn; and utilize an additional rejection device after a turner.

Rejection device 350, such as a punter, or rails that shunt (which would drive a case in an alternate rejection), or a trap door, or other.

A rejection device 350 may use a cylinder (with use of pneumatic power, or hydraulic power), or a servo driven device (such as a linear actuator), or a drive with belt (such as device with an encoder), or an alternate conveyance device (such as a belt conveyor, rope conveyor), or an indexing device.

Rejected products (removed from the working surface 29) may be deposited down a ramp, for example as illustrated in FIG. 31, or into a bin, or a crushing device (to compress product out of the product and compact products).

The rejection device 350 may be mounted in a way that is in a fixed position, or telescoping horizontally, or descending automatically.

The rejection device 350 may have variable positions, for various products, and those various positions could be manually configured, or automatically configured.

The apparatus 200 may be referred to as a product turner. When the product 2 is a product, the apparatus 200 may be referred to as the product turner. In view of the above, the product turner may include a rail that guides a gable top, or a hook that can make contact with a handle opening, or a bump turning device, or a star wheel. Any of these devices can be fixed position or variable position. The variable position could be manually operated or automatically operated.

The optional sensor assembly 650 is illustrated with a single sensor, for example such as a photo eye, to detect products that may back up to the assembly above. The back up eye may be on a timer that resets after a duration of time, or opens when there is an interruption of a viewable area (via photo eye, or proximity sensor, or mechanical flag, or a contactor that may have a wand, such as a limit switch).

The control unit 700, that may be referred to as a control box or a controller, may be designed with devices such as a programmable logic computer, or timers, or terminal strips, or contactors, or relays, safety switches or relays, ethernet switches, power receptacle, power transformer, or other sensitive electric components.

The control unit 700 may have external components, such as switches, horns, buttons, lights, buttons, or other; such as an emergency interface, such as an emergency stop button.

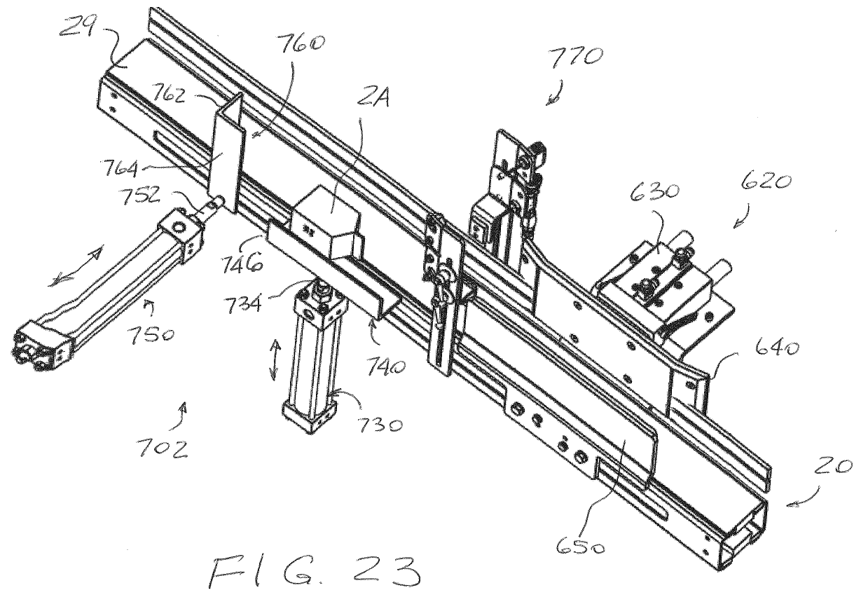

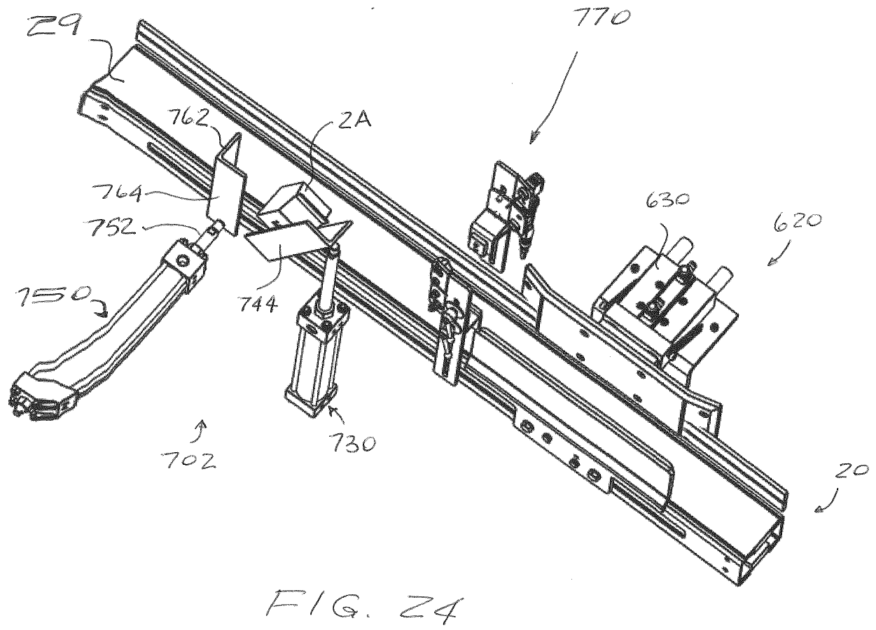

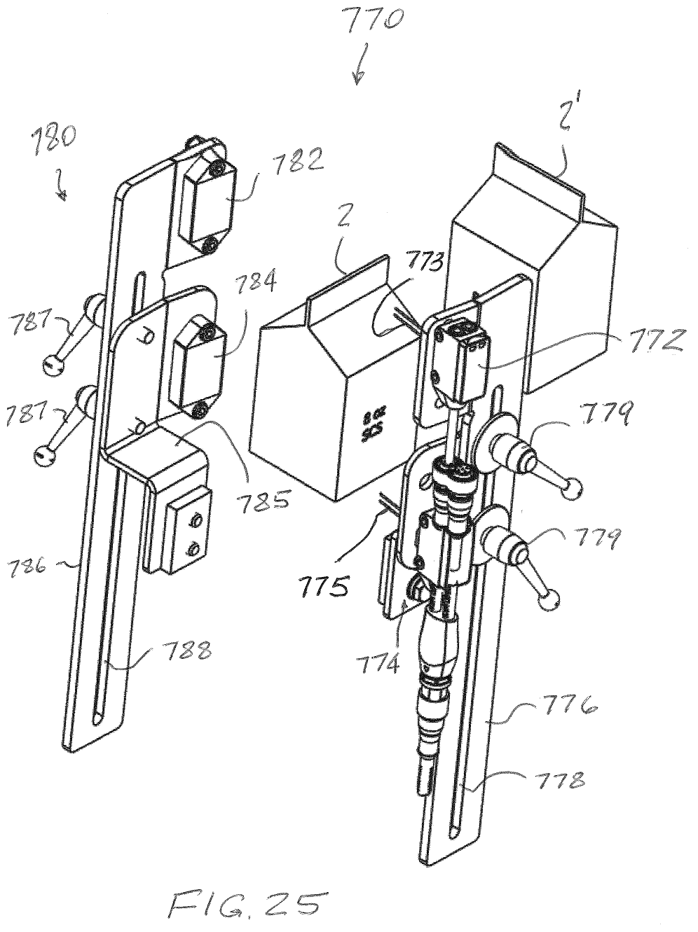

FIGS. 23-24 illustrate a product orienting apparatus 702. The product orienting apparatus 702 is be illustrated with an arm 740 connected to a linear actuator 740. Mounting provisions for the linear actuator 740 are omitted for the sake of clarity. The product orienting apparatus 702 may be provided as an optional component of any apparatus as described above.

The arm 740 is illustrated as being positioned along the side 26 of the conveyor 20 partially illustrated). One end 746 of the arm 740 has a pivot connection 742 with a stationary structure. The stationary structure may be the side 26 of the conveyor 20. The linear actuator 730 is illustrated as a cylinder being disposed to generate a movement in a vertical plane through the movable portion, being a rod 732. A pivot connection 734 is illustrated between the rod 732 and the arm 740. The linear actuator 730 pivots the arm 740 about the pivot connection 734 in a response to a signal. The arm illustrated as having an L-shaped configuration defined by flanges 742 and 744. The arm 740 moves the product 2 from a horizontal orientation, referenced by a numeral 2A, into a vertical or erect orientation, referenced with numeral 2 earlier. In other words, the apparatus 702 is designed to lift or rotate a fallen product from a horizontal position laying on its side surface into a vertical position standing on its bottom surface.

This apparatus 702 may be used when the product 2 is wider than the working surface 29 of the conveyor 20.

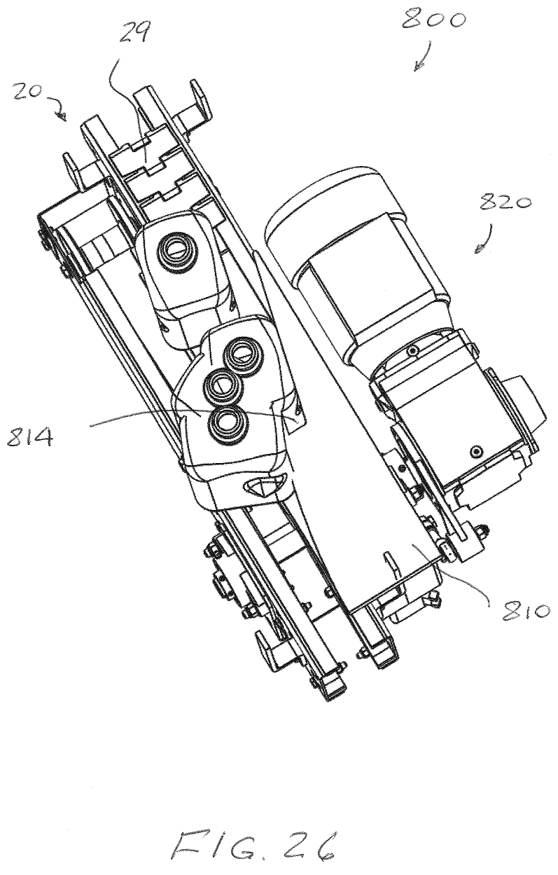

The signal may be generated from the control unit 700. A sensor 770 may be positioned adjacent the arm 740 to generate a signal to the control unit 700, the signal being representative of a condition of the product 2 advancing on the working surface 29 of the conveyor 20 along the flow direction F and above the arm 740. The sensor 770 is positioned to at least sense an upper portion of the product 2. The control unit 700 may be designed to generate an output signal in a response to a signal from the sensor 770 indicating a condition where the sensor 770 is not sensing the upper portion of the product 2. In other words, the signal to generate a linear movement of the rod 732 is initiated at the sensor 770 best described in a relationship to FIG. 25 below.

FIGS. 23-24 also illustrate a product orienting apparatus 702 with a first arm 740, a first pivot connection 742 between one end of the first arm 740 and a stationary component, a first actuator 730 designed to generate a linear motion in a first direction, a second pivot connection 734 between the first arm 740 and the first actuator 730, as described above. The first arm 740 moves between the first position and the second position.

FIGS. 23-24 also illustrate a second actuator 750 designed to generate a linear motion in a second direction, a second arm 760 attached to the second actuator 740, wherein the second arm 760 moves linearly between a third position and a fourth position.

The second arm 750 is illustrated as an L-shaped configuration with flanges 752 and 754 to act as a stop for the product being pivoted from a horizontal orientation 2A into a vertical orientation 2. The second cylinder 750 may be energized a period of time after receipt of the signal at the first cylinder 730, where the period of time is sufficient for the product to be lifted.

FIGS. 23-24 also illustrated a product clamp 620 as being positioned downstream of the arm 740 to hold back up stream pressure and relieve such back pressure onto the product 2A being in a contact with the arm 740. The clamp 620 is illustrated with a device 630 designed to generate a linear motion, a first component 640 attached to a moving portion of the device 630 and a second component 650 that is fixed across the working width 29 from the first component 640. The second component 650 is illustrated as being fixed to the conveyor 20.

The product clamp 620 is illustrated as positioned downstream of the arm 760 to hold back up stream pressure and relieve such back pressure onto the product 2 in a contact with the arm 760. More than one clamp 620 can be used in this application. The product clamp 620 may be actuated in a response to a receipt of the signal from the sensor 770. More than one clamp 620 can be used in this application.

FIG. 25 illustrates a sensor assembly 770.

The sensor assembly 770 may be provided with one sensor. The sensor 770 may be a photo eye 772 that emits a beam of light 773. When the sensor 770 is the photo eye 772, a reflector 782 is also provided. The sensor 772 is illustrated as being attached to a bracket 776. The sensor 772 may be adjustably attached to the bracket 776. The reflector 784 is illustrated as being attached to a bracket 786. The reflector 784 may be adjustably attached to the bracket 786. The bracket 7776 and 786 may be attached to the conveyor 20 to reduce installation costs.

The sensor 770 may be provided as a sensor assembly with two sensors 772 and 774 disposed at a distance from each other, where each sensor is designed to sense a portion of the product (product) 2. One sensor, illustrated as the sensor 772 may be mounted in a fixed position. The other sensor, illustrated as the sensor 774 may be mounted on a separate bracket that is adjustably attached to the bracket 776 by way of a slot 7878 and fasteners and/or clamp arms 787.

The sensor 772 or 774 may be a photo eye to emit beams of light 773 and 775 respectively. When the sensor 772 or 774 is the photo eye, a reflector assembly 780 is also provided.

The sensors 772 are illustrated as being adjustably attached to the bracket 776. The reflectors 782, 784 are illustrated as being attached to the bracket 786. One reflector, illustrated as reflector 784 may be mounted in a fixed position. The other reflector, illustrated as the reflector 784 may be mounted on a bracket 785 adjustable on the bracket 786 by way of a slot 788 and fasteners and/or clamp arms 787.

The sensor assembly 770 with two sensors 772 and 774 may be used to improve accuracy of sensing a fallen product 2A. The sensor 772, illustrated as disposed above the sensor 774 may be used to detect an upper portion of the product 2. The sensor 774, illustrated as disposed below the sensor 774 may be used to detect a lower portion of the product 2.

FIG. 25 also illustrate a product 2 provided as a container with a gable top 4 oriented along a flow direction F and a container 2′ with the gable top 4 oriented normal to the flow direction F. One of the two containers, for example such as a container 2′ is in a wrong orientation on the working surface 29 and needs to be turned in a horizontal plane.

The sensor 784 will detect such incorrect orientation in a response to receiving a reflection of the light beam from the reflector 782 that will be only partially blocked by the turned gable top 4.

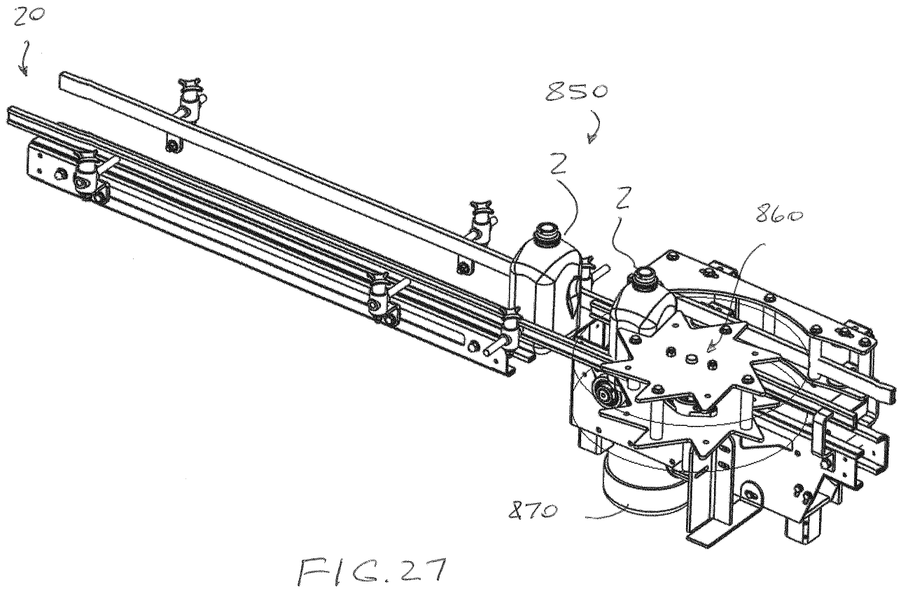

FIG. 26 illustrates a perspective view of a product turning device 800 with an arm 810 having a notch 814. The arm 810 is positioned to contact the product 2 conveying on the working surface 29 and reorient, by turning, the product about ninety degrees. Powered drive 820 is also illustrated.

FIG. 27 illustrates a perspective view of a product turning device 850 with a star-shaped wheel 860 that can be rotated by a drive 870.

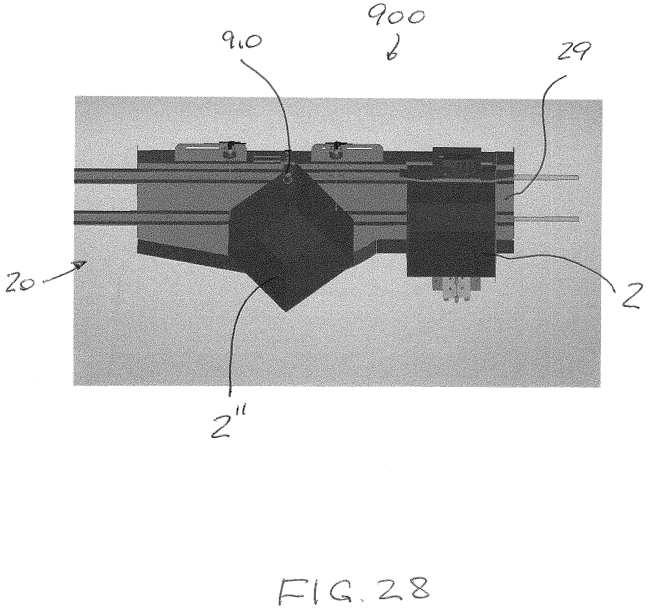

FIG. 28 illustrates a planar view of a bump turner device 900 with a component 910 positioned contact the product 2″″ conveying on the working surface 29 and turn the product into a position referenced by numeral 2.

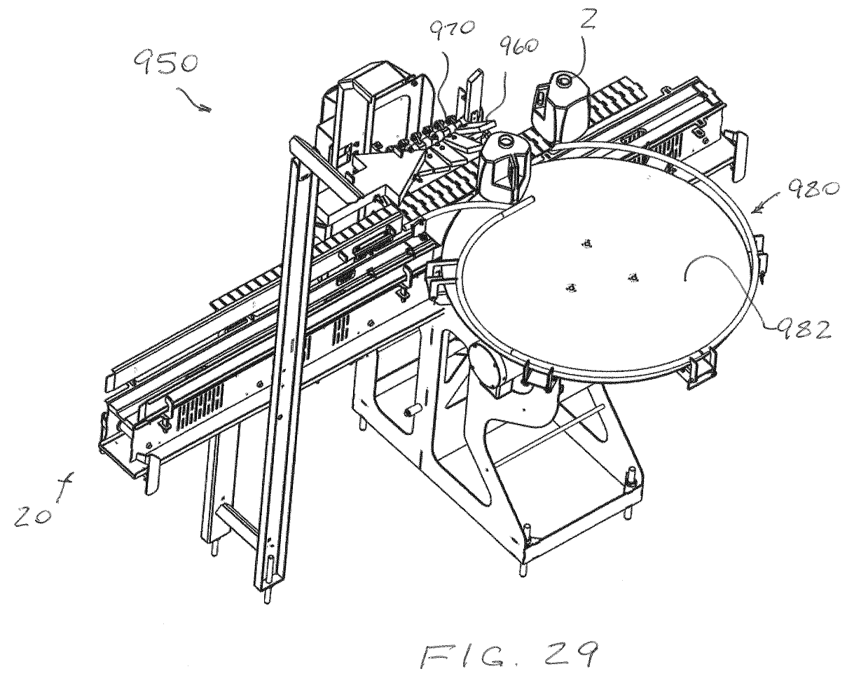

FIG. 29 illustrates a perspective view of a product reject accumulation apparatus 950 designed with fingers 960, each connected to an actuator 970 to transfer the product 2 onto a surface 982 of an accumulation table 980.

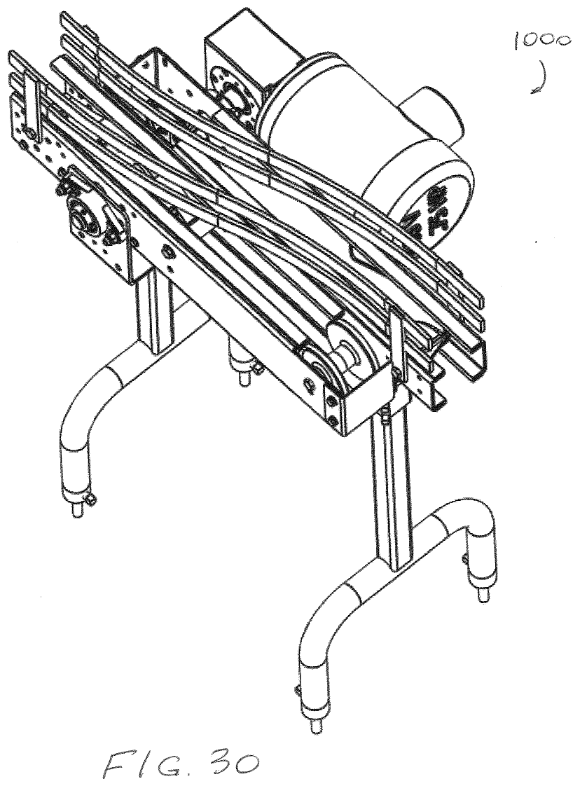

FIG. 30 illustrates a perspective view of a transfer conveyor 1000.

FIG. 31 illustrates a perspective view of an apparatus 1050 with an inclined chute 1060 to move rejected product 2 from the conveyor line by an actuator 10770 that may be any of the actuator types as described above. Mounting structure 1080 for the chute 1060 and actuator 1070 is also illustrated.

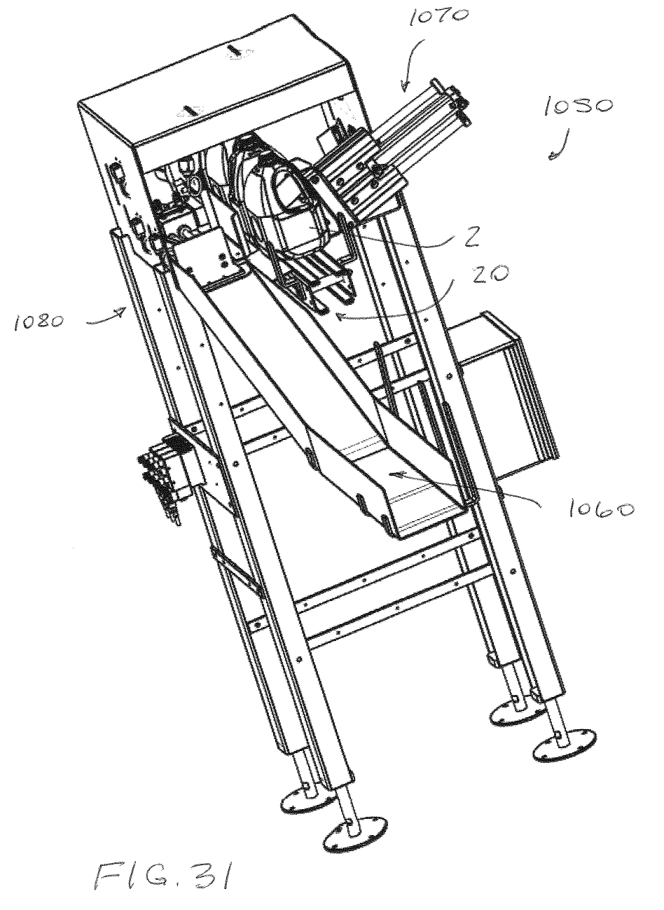

FIGS. 32A-32B illustrate an 1100 arm provided as a U-shaped component with portions 1110, 1120 and 1130 to at least partially cage the product 2A, with the middle portion 1120 of the U-shape acting as a stop. In FIG. 32A, the container 2A is laying on its side surface. In FIG. 32B, the container is erect after the arm 1100 has been pivoted at pivot 1130, for example by above described actuator 730.

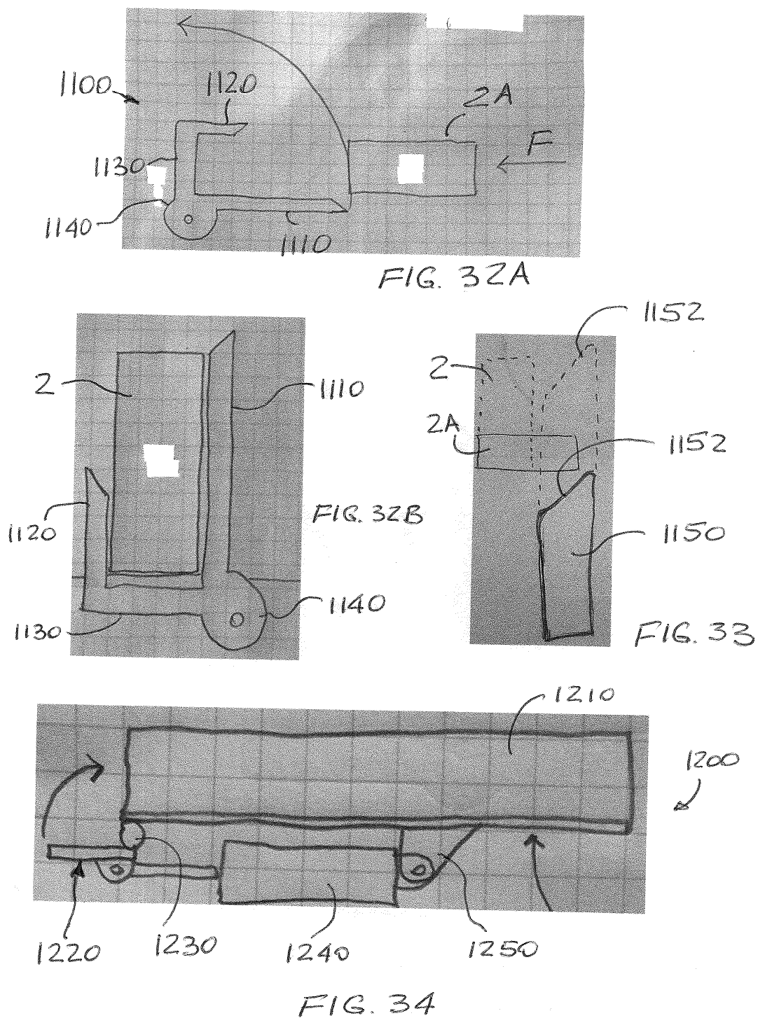

FIG. 33 illustrates an arm 1150 designed with a tapered end 1152 that would orient the product 2A into an erect product 2 by way of a linear movement in a vertical direction. The above described actuator 730 may be used to move the arm 1150 vertically.

FIG. 34 illustrates an apparatus 1200 adapted to orient a product 2, where the arm 1210 may be designed with a stop 1220 and a pivot 1230 to pivot the stop 1220 between a position closing the end of the arm 1210 and a position opening the end of the arm 1210. The pivot 1230 may be a hinge with a torsion spring to open the end of the arm due to a force of the conveying product behind the product being oriented. The arm 1220 may be moved by the above described actuator 730, that is omitted in FIG. 34.

The stop 1202 may be connected to an actuator 1240 mounted on the arm 1210 at least by way of the connection 1250. The actuator 1240 is illustrated as the actuator designed to generate a linear motion to pivot the stop 1220.

The stop 1220 with the actuator 1240 may function as the second arm and the second actuator as described above. In other words, the first and second arm with the first and second actuators may be provided as an integrated apparatus to orient the product 2 where the arm 1210 move in a first direction between the first and second positions and the second arm 1220 moves in a second directions between the third and fourth positions.

The subject matter has been described and illustrated, to plan and/or cross section illustrations that are schematic illustrations of idealized embodiments, for practical purposes so as to enable any person skilled in the art to which it pertains to make and use the same. As such, variations from the shapes of the illustrations as a result, for example, of manufacturing techniques and/or tolerances, are to be expected. It is therefore intended that all matters in the foregoing description and shown in the accompanying drawings be interpreted as illustrative and not in a limiting sense. For example, a region illustrated or described as flat may, typically, have rough and/or nonlinear features. Moreover, sharp angles that are illustrated may be rounded and rounded angles may be sharp. Thus, the regions illustrated in the figures are schematic in nature and their shapes are not intended to illustrate the precise shape of a region and are not intended to limit the scope of the present claims. It will be understood that variations, modifications, equivalents and substitutions for components of the specifically described embodiments may be made by those skilled in the art without departing from the spirit and scope of the invention as set forth in the appended claims.

Particular features, structures or characteristics may be combined as suitable in one or more embodiments of the disclosed subject matter. Each embodiment may be employed alone or in any combination, and may include any one or more of the above features in any suitable combination.

Anywhere the term “comprising” is used, embodiments and components “consisting essentially of” and “consisting of” are expressly disclosed and described herein.”

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Furthermore, the Abstract is not intended to be limiting as to the scope of the claimed subject matter and is for the purpose of quickly determining the nature of the claimed subject matter.

1.-83. (canceled)

84. An apparatus configured to correct an orientation of a product conveying within a plurality of products on a conveyor along a conveying direction.

85. The apparatus of claim 84, comprising:
an arm;
a first pivot connection between one end of the arm and a stationary component;
an actuator connected to the arm designed to generate a linear motion; and
a second pivot connection between another end of the arm and the actuator.

86. The apparatus of claim 85, wherein the arm includes a U-shaped configuration.

87. The apparatus of claim 85, wherein the arm includes a tapered end.

88. The apparatus of claim 84, comprising:
a first arm;
a first pivot connection between one end of the first arm and a stationary component;
a first actuator connected to the first arm and designed to generate a linear motion in a first direction;
a second pivot connection between another end of the first arm and the first actuator, wherein the first arm being movable between a first position and a second position;
a second arm;
a second actuator connected to the second arm and designed to generate a linear motion in a second direction; and
wherein the second arm being movable, by the second actuator, between a third position and a fourth position along the second direction.

89. The apparatus of claim 88, further comprising:
a pivot connection between the first arm and the second arm;
and
a connection between the second actuator and the first arm.

90. The apparatus of claim 84, comprising:
a first arm with a first end and a second end, the second end positionable above a working surface of a conveyor mediate first and second sides of the conveyor;
a fixed connection between the first end of the first arm and a first rail of the conveyor;
an adjustable connection between the second end of the first arm and the first rail, the adjustable connection designed to bias the product conveying on the conveyor toward a second rail of the conveyor;
a second arm with a first end and a second end, the second end of the second arm positioned above the working surface mediate first and second sides to turn orient the product in a response to a contact between the product and the second end of the first arm, the second end of the second arm having a Z-shaped configuration;
a fixed connection between the first end of the second arm and the second rail;
an actuator designed to generate a linear motion; and
a connection between the actuator and the second end of the second arm.

91. The apparatus of claim 84, comprising an arm with an edge notch between terminal ends of the arm.

92. The apparatus of claim 84, further comprising a sensor adapted to identify a condition of the product.

93. The apparatus of claim 92, wherein the sensor comprises:
a first bracket;
a second bracket;
two sensors mounted at a first distance from each other on the first bracket; and
two targets mounted at a second distance from each other on the second bracket.

94. The apparatus of claim 84, further comprising a first sensor and a second sensor positioned at a distance from each other.

95. The apparatus of claim 84, further comprising a device adapted to at least temporarily restrict conveyance of the product along the conveying direction.

96. The apparatus of claim 95, wherein the device comprises:
a first component;
a second component positionable at a distance from the first component; and
an actuator connected to one component from first and second components to pivot the one component toward to other component from the first and second components in a response to a receipt of a first control signal and pivot the one component away from the other component in a response to a second control signal.

97. The apparatus of claim 95, wherein the device comprises:
a first component;
a second component positionable at a distance from the first component, the distance sufficient to pass the product therethrough; and
an actuator connected to one component from first and second components to move the one component toward to other component from the first and second components in a response to a receipt of a first control signal and move the one component away from the other component in a response to a second control signal.

98. The apparatus of claim 84, further comprising:
a first sensor designed to sense a first condition of the product and output a first signal in a response to sensing the first condition; and
a second sensor designed to sense a second condition of the product and output a second signal in a response to sensing the second condition of the product.

99. The apparatus of claim 84, further comprising a device adapted to selectively apply a force to the product received between first and second components and relieve the force therefrom.

100. The apparatus of claim 84, further comprising a conveyor adapted to convey the plurality of products.

101. The apparatus of claim 84, further comprising:
a conveyor, at least including:
a first end,
a second end disposed opposite the first end along a length of the conveyor,
a first side between first and second ends;
a second side opposite the first side across a width of the conveyor, and
a working surface between first and second ends and between first and second sides;
a first rail extending along the first side of the conveyor and being mounted thereto;
a second rail extending along the second side of the conveyor; and
a device connected to one rail from first and second rails, the device adapted to move the one rail toward another rail from the first and second rails in a response to a receipt of a signal.

102. The apparatus of claim 84, comprising:
a first elongated arm with a first end and a second end and a bend between first and second arms;
a second elongated arm, the second arm being straight between terminal ends of the second arm; and
an assembly designed to adjust a distance of one end from first and second ends of the first elongated arm in a relationship to the second elongated arm.

103. An apparatus, comprising:
a sensor adapted to sense an orientation of a product;
a first device configured to correct the orientation of the product; and
a second device adapted to at least temporarily clamp the product.

104. An apparatus, comprising:
a sensor, the sensor at least including:
a first bracket,
a second bracket,
two sensors mounted at a first distance from each other on the first bracket, and
two targets mounted at a second distance from each other on the second bracket,
the sensor adapted to sense an orientation of a product;
a first device, the first device at least including:
an arm,
a first pivot connection between one end of the arm and
a stationary component,
a first actuator designed to generate a linear motion in a first direction,
a second pivot connection between another end of the arm and the first actuator, wherein the arm moves between a first position and a second position,
a second actuator designed to generate a linear motion in a second direction, and
a second arm attached to the second actuator, wherein the second arm moves linearly between a third position and a fourth position along the second direction;
a second device, the second device at least including:
a first component;
a second component positionable at a distance from the first component, the distance sufficient to pass the product therethrough, and
an actuator connected to one component from first and second components to move the one component toward to other component from the first and second components in a response to a receipt of a first control signal and move the one component away from the other component in a response to a second control signal,
the first device adapted to correct the orientation of the product conveying within a plurality of products on a conveyor along a conveying direction;
the second device adapted to at least temporarily conveyance of remaining products from the plurality of products.
